(19) United States
(12) Patent Application Publication
(10) Pub. No.: US 2017/0178124 A1
(43) Pub. Date: Jun. 22, 2017

(54) PROCESSING SECURE ELECTRONIC PAYMENT TRANSACTIONS

(71) Applicant: Facebook, Inc., Palo alto, CA (US)

(72) Inventor: Amir Mesguich Havilio, Palo Alto, CA (US)

(21) Appl. No.: 14/975,111

(22) Filed: Dec. 18, 2015

(51) Int. Cl. G06Q 20/38; G06Q 20/40; G06Q 20/36

(52) U.S. Cl. CPC G06Q 20/382; G06Q 20/3674; G06Q 20/401

(57) ABSTRACT

The present disclosure relates to systems, methods, and devices for enabling efficient and secure electronic payment transactions. For example, one or more implementations involve leveraging a banking application on a client device to facilitate payment transactions. In particular, one or more embodiments process the payment transaction using the payment account of the user using an authorization obtained via the banking application. One or more embodiments also provide tokenized credentials for processing future payment transactions.

### BACKGROUND

1. Technical Field

One or more embodiments described herein relate generally to systems and methods for enabling electronic payment transactions. More specifically, one or more embodiments relate to systems and methods of enabling electronic payment transactions between users of a social networking system.

2. Background and Relevant Art

Electronic payment systems typically allow users to perform payment transactions with others via software applications on one or more types of devices (e.g., desktop devices and mobile devices). Some electronic payment systems allow users to perform payment transactions with financial institutions or merchants. Other electronic payment systems allow users to perform payment transactions with other users of the electronic payment systems (i.e., peer-to-peer payment transactions).

Conventional electronic payment systems attempt to provide a convenient method for transferring money between users. Conventional electronic payment systems, however, have drawbacks that often result in an unsatisfactory process for users. Specifically, conventional systems typically require a user to provide payment credentials. For example, conventional systems often require a user to enter account numbers for the user's payment account into an application or website of a merchant or a third-party application before allowing the users to enter into payment transactions with other users. By requiring users to provide payment credentials to an application other than the user's bank, conventional systems increase potential security risks. Furthermore, some users are hesitant to provide payment credential information to third parties.

Payment transactions between users and merchants typically require users to pay via one or more approved methods of payment (e.g., cash, check, credit card, debit card, gift card). Often times, particularly in the case of small businesses, merchants may only accept a few methods of payment to avoid contracting costs or transaction costs associated with one or more of the payment methods. Thus, a user desiring to purchase products or services from different merchants, each of which may accept different methods of payment, may be required to carry several methods of payment.

Additionally, using physical methods of payment can introduce several security risks. For example, using physical debit cards or credit cards to pay for products or services allows others (e.g., merchant employees, other customers) to see credit card numbers or other personal financial information. Exposing financial information to businesses can often result in employees or other customers stealing the financial information and using the information to commit fraud.

Along related lines, while commerce applications can increase shopping ease and allow users to make purchases without visiting a brick and mortar store, the checkout process in many commerce applications can be inconvenient. For instance, commerce applications typically require a user to provide detailed payment information. In many cases, a user may need to fill-in up to twenty information fields. It is common for potential consumers using a commerce checkout process to have difficulty entering payment information, run-out of time, or question otherwise become frustrated with the checkout process. Such frustrations often cause potential consumers to abandon their commerce transactions. Frustration with commerce checkout processes is often exacerbated when using a mobile device due to the small screen and difficulty of typing-in large amounts of information.

Additionally, bank account numbers, bank routing numbers, and credit card numbers are often long and difficult to remember. Providing payment credentials to an electronic payment application often necessitates that users have a debit card or a check on hand if the users do not have the account information memorized. Thus, requiring users to enter payment credentials to initiate a payment transaction with another user can be inconvenient because users do not always have the payment credentials memorized or readily available.

Furthermore, conventional electronic payment systems generally request that users re-input credentials after a certain amount of time has passed. Specifically, conventional systems use debit card information or credit card information to associate a debit account or a credit account with a user. Given that debit cards and credit cards have expiration dates, users that provide payment credentials associated with a debit card or credit card must re-enter the payment credentials after the corresponding expiration date. Thus, providing payment credentials to numerous different merchants and/or third-party electronic payment systems can be inconvenient when the payment credentials expire. In some instances, users may even forget to re-enter the payment credentials, causing processing failure of automatic electronic payments.

Many conventional electronic payment systems have several drawbacks that often cause user frustration, confusion, and result in an unsatisfactory payment process. One such drawback of conventional electronic payment systems is that they are typically standalone systems with limited functionality, which a merchant must implement and to which a user must subscribe. Specifically, some conventional electronic payment systems include proprietary software from the merchant that is limited to allowing users to interact with only a specific merchant. Other conventional electronic payment systems that allow users to perform payment transactions with different merchants often limit users just to performing payment transactions.

The limited nature of conventional electronic payment systems also adds inconvenience. In particular, the standalone nature of conventional electronic payment systems typically requires that users open a separate application dedicated just to payment transactions in order to send or receive a payment. The inconvenience of the standalone nature of conventional electronic payment systems can discourage users from using such systems.

Accordingly, there are a number of disadvantages with conventional electronic payment systems and methods.

### SUMMARY

One or more embodiments described herein provide benefits and/or solve one or more of the foregoing or other problems in the art with systems and methods to enable secure electronic payment transactions. In particular, one or more embodiments allow users to engage in electronic payment transactions via a networking system without providing payment credentials to the networking system. One or more embodiments identify a payment request by the user to initiate a payment transaction with a recipient. The systems and methods can determine a financial system associated with a payment account of the user based on banking/financial applications installed on the user's client device and notify the financial system of the payment request. Additionally, one or more embodiments switch to a login interface associated with the financial system for the user to input login information for the payment account, and process the payment transaction based on the provided login information. Thus, the systems and methods initiate a secure payment transaction without receiving payment credentials or login information from the user at the networking system.

Additionally, one or more embodiments of the systems and methods authorize payment transactions using tokenized credentials. Specifically, after a user authorizes with the payment network a first time by providing login information to the payment network, the systems and methods receive a tokenized credential associated with the payment account. Upon identifying an additional payment request to initiate a payment transaction for a user, one or more embodiments send the tokenized credential to the payment network in connection with the payment request to authorize the payment transaction. By storing a tokenized credential corresponding directly to the user's payment account, the systems and methods provide a secure, fast method of payment that does not expire.

Additional features and advantages of the embodiments will be set forth in the description that follows, and in part will be obvious from the description, or can be learned by the practice of such exemplary embodiments. The features and advantages of such embodiments can be realized and obtained by means of the instruments and combinations particularly pointed out in the appended claims. These and other features will become more fully apparent from the following description and appended claims, or can be learned by the practice of such exemplary embodiments as set forth hereinafter.

### BRIEF DESCRIPTION OF THE DRAWINGS

In order to describe the manner in which the above recited and other advantages and features of the disclosure can be obtained, a more particular description of the disclosure briefly described above will be rendered by reference to specific embodiments thereof that are illustrated in the appended drawings. It should be noted that the figures are not drawn to scale, and that elements of similar structure or function are generally represented by like reference numerals for illustrative purposes throughout the figures. In the following drawings, bracketed text and blocks with dashed borders (e.g., large dashes, small dashes, dot-dash, dots) are used herein to illustrate optional features or operations that add additional features to embodiments of the disclosure. Such notation, however, should not be taken to mean that these are the only options or optional operations, and/or that blocks with solid borders are not optional in certain embodiments of the disclosure. Understanding that these drawings depict only typical embodiments of the disclosure and are not therefore to be considered to be limiting of its scope, the disclosure will be described and explained with additional specificity and detail through the use of the accompanying drawings in which:

FIG. 1 illustrates a schematic diagram of an environment including a payment system that facilitates the sending of payments in accordance with one or more embodiments;

FIG. 2 illustrates a detailed schematic diagram of the environment of FIG. 1 in accordance with one or more embodiments;

FIGS. 3A-3B illustrate a sequence-flow diagram illustrating interactions as part of a payment transaction process between a sender and a recipient in accordance with one or more embodiments;

FIG. 4 illustrates a sequence-flow diagram illustrating interactions as part of a payment transaction process between a sender and a recipient in accordance with one or more embodiments;

FIGS. 5A-5E illustrate user interfaces for requesting a payment transaction as described in reference to FIGS. 3A-3B in accordance with one or more embodiments;

FIG. 6 illustrates a flow chart of a series of acts in a method of enabling secure payment transactions in accordance with one or more embodiments;

FIG. 7 illustrates a block diagram of an example computing device in accordance with one or more embodiments;

FIG. 8 illustrates an example network environment of a social networking system in accordance with one or more embodiments; and

FIG. 9 illustrates an example social graph for a social networking system in accordance with one or more embodiments.

### DETAILED DESCRIPTION

Embodiments of the present disclosure provide a payment system that provides users with the ability to engage in secure electronic payment transactions. In particular, one or more embodiments provide a payment system that allows users to engage in electronic payment transactions with recipients via a networking system. For example, the payment system allows a user to initiate a payment transaction with a recipient via a networking application without the networking system receiving payment credentials associated with the user. Additionally, the payment system allows the user to initiate a payment transaction by authorizing with a financial system using information that the user is more likely to have readily available than payment account numbers or other payment credential information.

By allowing users to engage in payment transactions without requiring the users to provide payment credentials or account information to the networking system, the payment system reduces some of the risks associated with electronic payment transactions. Specifically, the payment system reduces the risk of security breaches by limiting the number of different systems that have access to the payment credentials. For example, the payment system allows the user to interact directly with the financial system by the user providing the login information to the financial system to initiate a payment transaction with a recipient. Additionally, processing payment transactions in such a way may reduce overall transaction costs, and may also simplify the standards to which the payment transactions must conform.

One or more embodiments of the present invention increase the ease and efficiency of commerce payment and checkout processes. In particular, one or more embodiments help reduce checkout inconveniences and associated abandoned transactions by leveraging a payment account of the user. The payment system allows a user to easily and securely complete commerce transactions, which simplifies the user's checkout experience and reduces barriers to purchase products of otherwise send money.

As mentioned, the payment system allows users to engage in payment transactions via a networking system without providing actual payment credentials or other account information to the networking system. Specifically, the payment system determines a financial system associated with a payment account of a user in response to identifying a payment request by the user via a networking application on a client device of the user. For example, the payment system determines a financial system corresponding to banking applications that are installed on the client device.

In one or more embodiments, the payment system allows the user to interact with the financial system to authorize the payment transaction. In particular, the payment system notifies the financial system of the payment request to initiate the payment transaction. The notification provides information to the financial system in association with the payment request to allow the financial system to process the payment transaction upon authorization of the payment transaction.

According to one or more embodiments, the payment system performs and app switch to a login interface associated with the financial system. For example, the payment system causes the client device to switch from an interface of the network application to a login interface for a banking application of the financial system to allow the user to log in to the user's payment account with the financial system. Thus, the user provides the login information (e.g., account name and password) to the financial system via the banking application without providing the login information to the networking system. The financial system verifies the login information that the user enters into the login interface and authorizes the payment transaction based on the previously provided information associated with the payment request.

In one or more embodiments, the payment system processes the payment transaction using the payment account of the user using an authorization from the financial system. For example, the payment system can switch back to the networking application to request authorization from the user to process the payment transaction at the financial system. The networking application can send the user authorization to the financial system, and the financial system can process the payment transaction. Alternatively, the financial system can process the payment transaction without additional authorization from the user.

In one or more embodiments, after the payment transaction is processed, the payment system receives a response from the financial system indicating that the payment transaction is initiated. In particular, the payment system receives a tokenized credential from the financial system that allows the payment system to process future payment transactions with the financial system without the user re-entering the login information. Thus, the payment system can allow the user to engage in a plurality of payment transactions without the networking system ever receiving payment credentials or login information for the user's payment account. Alternatively, the payment system can require the user to re-enter the login information at the login interface each time the user requests to initiate a payment transaction.

One will appreciate in light of the disclosure herein, by having the financial system process a payment directly from the payment account of a user, there is no middle man that has access to sensitive information. Thus, the risk associated with making online payment is reduced. Furthermore, a recipient of a payment also has more security. In particular, the financial system will only process the payment if there is money/credit available in the payment account. Thus, unlike credit cards or other types of payment credentials there is little or no risk that the transaction is not properly funded.

As used herein, the term “payment transaction” refers to any type of electronic transaction exchanging currency or credits between two or more entities. For example, a payment transaction can be a financial electronic transaction between two users of a payment system. In another example, a payment transaction can be a financial electronic transaction between a user and a financial institution or other multi-person entity. Additionally, a payment transaction can represent a monetary gift, a payment of a debt, a funding of a loan, a payment in consideration for a purchase of goods and/or services, or any other type of monetary transfer. In addition, a payment transaction can be made in one or more currencies and converted, based on an exchange rate for example, to one or more additional currencies.

As used herein, the terms “payment account” and “payment credential” can refer to a user's bank, deposit, or other financial account from which money can be deducted or to which money can be deposited. For example, a payment account can include a checking account or a savings account. Accordingly, the terms “account information” and “payment credential information” refer to information associated with a user's payment account. For instance, account information can include login information, account numbers, routing numbers, or other information that is descriptive of, or allows access to, a payment account.

As used herein, the terms “networking application” and “banking application” refer to client applications that run on a client device. In particular, a networking application can include an application associated with a networking system that allows a user to interact with other users of the networking system. A banking application can include an application associated with a financial system that allows a user to manage a payment account with the financial system. In one or more embodiments, the networking application and the banking application are mobile applications running on a mobile device.

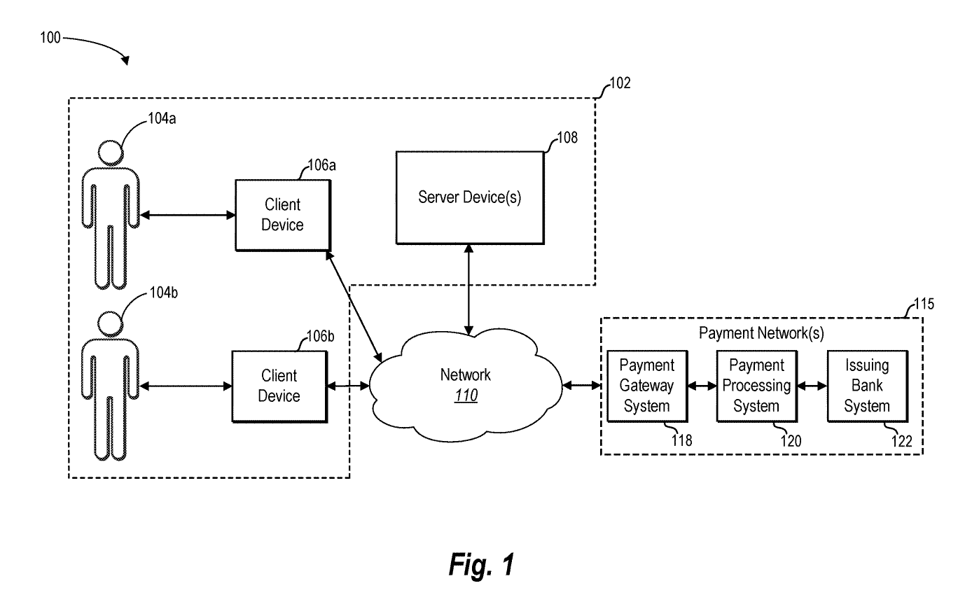

FIG. 1 is a schematic diagram illustrating an environment 100 for processing payment transactions. The environment 100 includes a payment system 102 that facilitates payment transactions between two or more users of a networking system. Hereafter, a more detailed description of the components and processes of the payment system 102 are provided in relation to the remaining figures.

As illustrated by FIG. 1, the environment includes a payment system 102 that communicates with a payment network 115 to communicate and process payment transactions between user 104a and user 104b (collectively “users”) using corresponding client devices 106a, 106b. As further illustrated in FIG. 1, the client devices can communicate with server device(s) 108 via a network 110. As mentioned, the payment system 102 can communicate with the payment network 115 via the network 110 to process the payment transactions between the users. Although FIG. 1 illustrates a particular arrangement of the users, the client devices 106a, 106b, the network 110, the server device(s) 108, and the payment network 115, various additional arrangements are possible. For example, the client devices 106a, 106b may directly communicate with the server devices, bypassing the network.

As briefly mentioned above, FIG. 1 shows that the users 104a, 104b can use the corresponding client devices 106a, 106b to communicate with one another via the server device(s) 108. Specifically, one or more embodiments integrate a messaging system with the payment system 102. For example, the users can exchange electronic messages containing text, digital content (e.g., audio, images, video), location information, and other forms of data and information, as described in more detail below. For instance, the user 104a, using client device 106a, can compose a message intended for the user 104b. After composing the message, the user 104a can cause the client device 106a to send the message intended for the user 104b via the network 110 to the server device(s). The server device(s) 108 can identify the user 104b as the intended recipient, and forward the message to the client device 106b associated with the user 104b.

In addition to allowing the users 104a, 104b to exchange electronic communications, the payment system 102 allows the users 104a, 104b to send and receive monetary payments to and from one another. In one or more embodiments, the payment system 102 allows a user to define and send a payment message to another user in connection with a message exchange between users. Alternatively, the payment system 102 can allow a user to define and send a payment message to another user in accordance with a product listing or predefined payment structure. For instance, the payment system 102 can allow the user 104a to send a payment to user 104b via the server device(s) 108 and the payment network 115. Likewise, user 104a can receive notice of the payment, and accept or decline the payment. As will be explained in more detail below, the server device(s) 108 can communicate with the payment network 115 to coordinate a transaction that facilitates the payment between the users (i.e., their accounts).

While the payment system 102 can facilitate a payment between users 104a and 104b, the payment system 102 can also facilitate a payment between more than two users, such as a group of users. For example, a user may send a payment to a plurality of users. In one or more embodiments, a user can send payments to multiple users within the same payment transaction. Furthermore, in one or more embodiments, a group of users may be provided with the ability to send and/or receive payments through the payment system 102, either to or from other groups or individual users.

While FIG. 1 illustrates the users 104a, 104b as people, the users 104a, 104b may include other entities, such as business, government, or other entities. For example, the user 104a can use the payment system 102 to provide a payment to a business for services or products. For instance, the user 104a can communicate with a business via the social networking system on the server device(s), and ultimately decide to make a purchase of a product or service from the business. Using the same social networking system, the user 104a can then send a payment for the product or service to the business. Similarly, a business may send a payment to other businesses or vendors, whether an individual or a business entity.

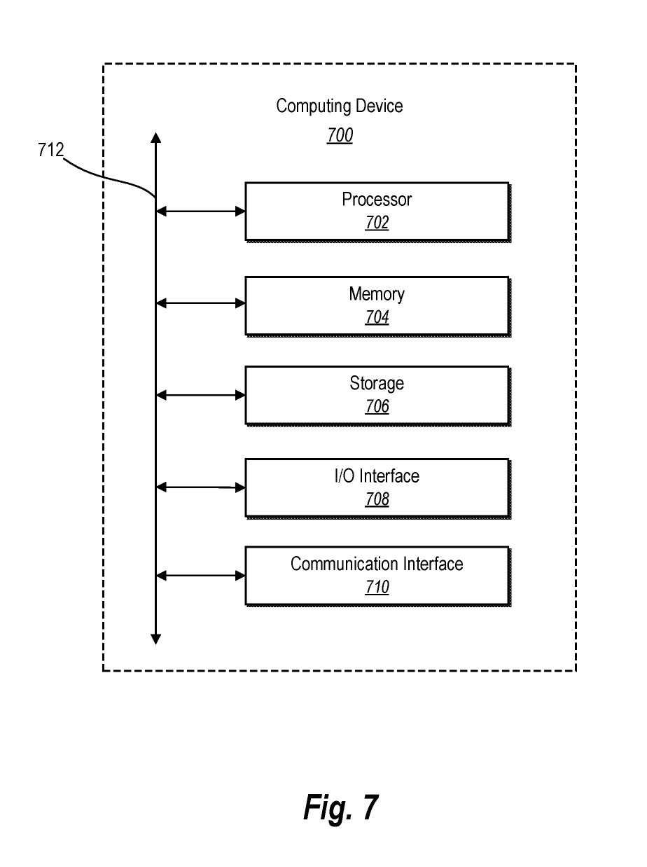

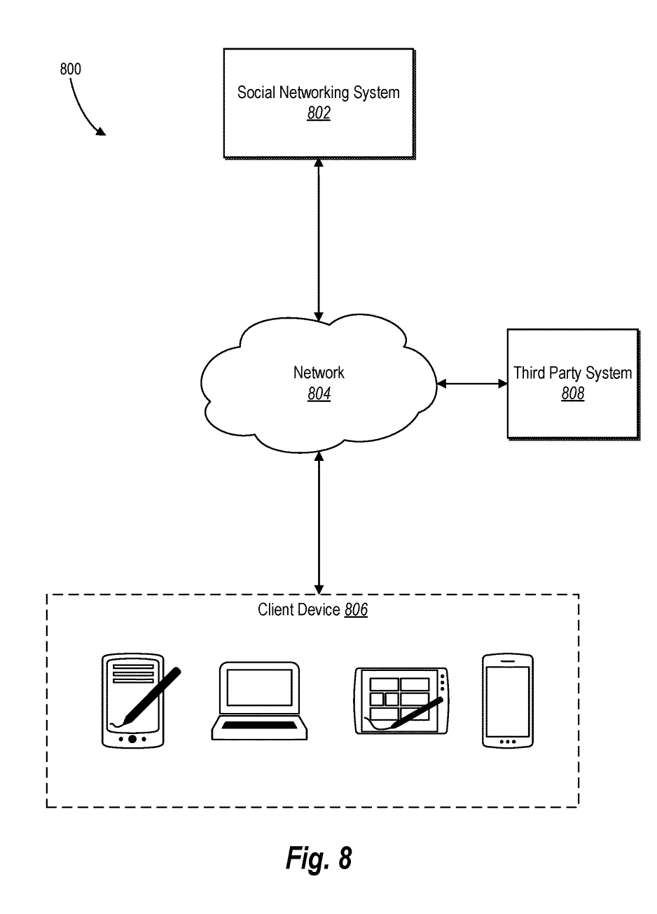

As FIG. 1 illustrates, the users 104a and 104b can interact with the client devices 106a and 106b, respectively. In one or more embodiments, one or more of the client devices 106a, 106b include mobile computing devices (e.g., smartphones, tablets). In other embodiments, the client devices 106a, 106b can also include laptops, desktops, or any other type of computing device. FIG. 7 and the corresponding description provide additional information regarding computing devices. Moreover, and as mentioned above, the client devices 106a, 106b can communicate with each other through the network 110. In one or more embodiments, the network 110 includes the Internet or World Wide Web. The network 110, however, can include one or more private and/or public networks that use various communication technologies and protocols, as further described below with reference to FIG. 8.

As illustrated in FIG. 1, the payment network 115 includes a payment gateway system 118, a payment processing system 120, and an issuing bank system 122. In alternative embodiments, however, the payment network 115 can include more or fewer components depending on a particular embodiment of the environment. For example, the payment network 115 can include only the bank system 122 such that the server device(s) 108 communicate directly with the bank system 122.

In one or more embodiments, for example, the payment system 102 communicates with the payment network 115 to authorize and process a transaction. For example, the payment system 102 sends a transaction to the payment gateway system, as shown in FIG. 1. Once the payment gateway system receives the transaction, the payment gateway 118 can send the transaction to the processor (e.g., payment processing system 120) used by a payment recipient user's acquiring bank. Based on the method of the payment (e.g., sender user's account), the payment processing system 120 can transmit the transaction to an appropriate issuing bank system 122 based on the user account.

The issuing bank system 122 either approves or declines the transaction (e.g., based on information received from the payment system 102). In one or more embodiments, the issuing bank system 122 can process the payment transaction according to the capabilities of the payment account associated with the user, such as via Automated Clearing House (ACH), and sends the decision back to the payment processing system 120. The payment processing system 120 can then forward the decision to the payment gateway system, and in one or more embodiments, the payment gateway system can maintain the details related to the transaction and the decision. The payment processing system 120 also sends the decision to the payment system 102.

In at least some embodiments, if the acquiring bank is different than the issuing bank, the acquiring bank then sends a funding request in satisfaction of the deposit amount to the payment processing system 120, which passes the funding request to the issuing bank system 122. The issuing bank system 122 can post the transaction to the sender user's account and pass a release of the funds to the payment processing system 120, and then the acquiring bank. Additional details relating to the specific systems, methods, components and process of the payment system 102 are described below.

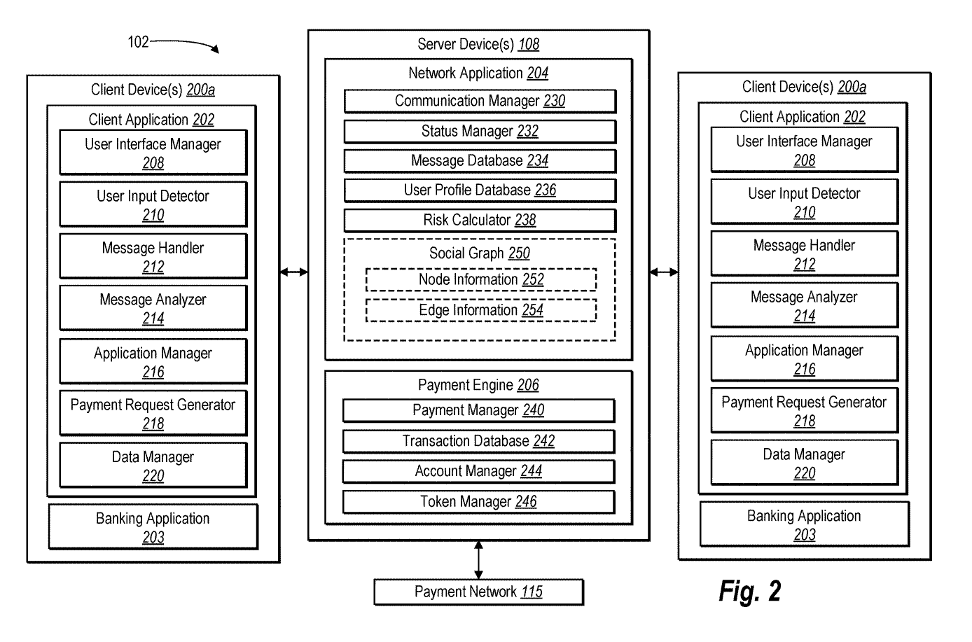

FIG. 2 illustrates a schematic diagram illustrating additional details of the environment including the payment system 102. As shown, the payment system 102 can include client devices 200a, 200b, server device(s), and payment network 115. In general, the payment system 102 can allow a user of the client device 200a to send a payment to or receive a payment from a user of client device 200b. Additionally, the system can allow the user of the client device 200a to exchange messages with a user of the client device 200b.

As shown, the payment system 102 can include various components on the client devices 200a, 200b and the server device(s). For example, FIG. 2 illustrates that the client devices 200a, 200b can each include a client application 202 (also referred to herein as a “networking application”) with various components and a banking application 203, and the server device(s) 108 can include a network application 204 and a payment engine 206 with various components. The components of the client applications 202, the network application 204, and the payment engine 206 can work together to allow the users to send payments, receive payments, and exchange messages as described in greater detail below.

As shown, the client application 202 can include a user interface manager 208, a user input detector 210, a messaging handler 212, a message analyzer 214, an app manager 216, a payment request generator 218, and a data manager 220. FIG. 2 illustrates that the network application 204 can include a communication manager 230, a status manager 232, a message database 234, a profile database 236, and a risk calculator 238. As described below, the network application 204 can also optionally include a social graph 250, which includes node information 252 and edge information 254. FIG. 2 also illustrates that the payment engine 206 can include a payment manager 240, a transaction database 242, an account manager 244, and a token manager 246.

Each of the components of the client device(s) 200a, 200b and server device(s) 108 can communicate with each other using any suitable communication technologies. It will be recognized that although the components are shown to be separate in FIG. 2, any of the components may be combined into fewer components, such as into a single facility or module, or divided into more components as may serve a particular embodiment. While FIG. 2 describes certain components as part of the client applications 202 and other components as part of the network application 204, the present disclosure is not so limited. In alternative embodiments, one or more of the components shown as part of the client application 202 can be part of the network application 204 or vice versa. Similarly, one or more components shown as part of the network application 204 can be part of the payment engine 206 or vice versa.

The components can comprise software, hardware, or both. For example, the components can comprise computer instructions stored on a non-transitory computer-readable storage medium and executable by at least one processor of the client devices 200a, 200b or the server device(s). When executed by the at least one processor, the computer-executable instructions can cause the client device(s) 200a, 200b or the server device(s) 108 to perform the methods and processes described herein. The components can comprise hardware, such as a special purpose processing device to perform a certain function or group of functions. Additionally, or alternatively, the components can comprise a combination of computer-executable instructions and hardware.

In one or more embodiments, the client application 202 can be a native application installed on one of the client devices 200a, 200b. For example, client application 202 may be a mobile application that installs and runs on a mobile device, such as a smart phone or a tablet. Alternatively, the client application 202 can be a desktop application, widget, or other form of a native computer program. Alternatively, the client application 202 may be a remote application that the client device accesses. For example, the client application 202 may be a web application that is executed within a web browser of the client device.

As mentioned above, and as shown in FIG. 2, the client application 202 can include a user interface manager 208. The user interface manager 208 can provide, manage, and/or control a graphical user interface (or simply “user interface”) that allows a user to compose, view, and send messages as well as send payments. For example, the user interface manager 208 can provide a user interface that facilitates the composition of a message, such as an instant message, social network post, or a payment. Likewise, the user interface manager 208 can provide a user interface that displays messages and payments received from other users.

More specifically, the user interface manager 208 may facilitate the display of a user interface (e.g., by way of a display device associated with the client device 200a, 200b). For example, the user interface may be composed of a plurality of graphical components, objects, and/or elements that allow a user to compose, send and receive messages or payments. More particularly, the user interface manager 208 may direct the client device 200a, 200b to display a group of graphical components, objects and/or elements that enable a user to engage in payment transactions and messaging threads.

In addition, the user interface manager 208 may direct the client device 200a, 200b to display a one or more graphical objects or elements that facilitate user input for composing and sending a message. To illustrate, the user interface manager 208 may provide a user interface that allows a user to provide user input to the client application 202. For example, the user interface manager 208 can provide one or more user interfaces that allow a user to input one or more types of content into a message. As used herein, “content” refers to any data or information to be included as part of a message. For example, the term “content” will be used herein to generally describe, text, images, digital media, files, location information, payment information and any other data that can be included as part of a message.

As discussed above, one example of content that can be included in a message is a loan request from a sender user (or simply “sender”) to a recipient user (or simply “recipient”). In one or more embodiments, the user interface manager 208 can provide a user interface to allow a user to quickly and securely engage in a payment transaction with one or more other users. For example, the user interface manager 208 can provide one or more input fields and/or one or more user selectable elements with which a sender can interact to create and send a payment request message. Similarly, the user interface manager 208 can allow a recipient to create and send an acceptance message associated with a payment transaction.

In addition to the forgoing, the user interface manager 208 can receive instructions or communications from one or more components of the client application 202 to display updated message information, updated status of a payment, updated status of a loan request, and/or updated available actions. The user interface manager 208 can update an available option based on whether a particular option is available at a particular point within the transaction process. The user interface manager 208 can add, remove, and/or update various other selectable actions within the sender and/or receiver status messages.

The user interface manager 208 can facilitate the input of text or other data to be included in an electronic communication or message associated with a payment transaction. For example, the user interface manager 208 can provide a user interface that includes a keyboard. A user can interact with the keyboard using one or more touch gestures to select text to be included in an electronic communication. For example, a user can use the keyboard to enter a message to accompany and/or describe a payment transaction in an electronic communication. In addition to text, the user interface, including the keyboard interface, can facilitate the input of various other characters, symbols, icons, or other character information.

As further illustrated in FIG. 2, the client application 202 can include a user input detector 210. In one or more embodiments, the user input detector 210 can detect, receive, and/or facilitate user input in any suitable manner. In some examples, the user input detector 210 can detect one or more user interactions with respect to the user interface. As referred to herein, a “user interaction” means a single interaction, or combination of interactions, received from a user by way of one or more input devices.

For example, user input detector 210 can detect a user interaction from a keyboard, mouse, touch pad, touchscreen, and/or any other input device. In the event the client device 200a, 200b includes a touchscreen, the user input detector 210 can detect one or more touch gestures (e.g., swipe gestures, tap gestures, pinch gestures, or reverse pinch gestures) from a user that forms a user interaction. In some examples, a user can provide the touch gestures in relation to and/or directed at one or more graphical objects or graphical elements of a user interface.

The client application 202 can perform one or more functions in response to the user input detector 210 detecting user input and/or receiving other data. Generally, a user can control, navigate within, and otherwise use the client application 202 by providing one or more user inputs that the user input detector 210 can detect. For example, in response to the user input detector 210 detecting user input, one or more components of the client application 202 allow a user to select a recipient for a message, compose a message, select content to include in a message, and/or send a message to the recipient. In addition, in response to the user input detector 210 detecting user input, one or more components of the client application 202 allow a user to navigate through one or more user interfaces to review received messages, contacts, payment history, etc.

As further illustrated in FIG. 2, the client application 202 can include a message handler 212 that manages messages provided to or sent from the client application 202. For example, the message handler 212 can interact with the user interface manager 208 and the user input detector 210 to coordinate the sending and receiving of messages using the client application 202. The message handler 212 may direct the sending and receiving of messages to and from the network application 204 over the course of an electronic messaging session among a plurality of participants. The message handler 212 may organize incoming and outgoing messages and direct the user interface manager 208 to display messages.

In one or more embodiments, the message handler 212 can facilitate receiving and sending data via the client application 202. In particular, message handler 212 can facilitate sending and receiving messages. For example, the message handler 212 can package content to be included in a message and format the message in any necessary form that is able to be sent through one or more communication channels and using an appropriate communication protocol, as described herein. To illustrate, the message handler 212 can format a payment request message to send to the server device(s) 108 for processing a payment transaction with one or more other client devices. Likewise, the message handler 212 can process messages the client device 204 receives from other users.

In addition to providing communication functions for the client application 202, the message handler 212 can provide access to message data. For example, the message handler 212 can access data that represents a list of contacts, or one or more groups of contacts, to include and recipients to a message. To illustrate, the message handler 212 can obtain and provide data representing a contact list to the user interface manager 208 to allow the user to search and browse a contact list, and ultimately select an individual contact or group of contacts to include as recipients of a message. In one or more embodiments, a social networking system can maintain remote contact list data (e.g., a “friends list”), and the message handler 212 can access the contact list data on the social networking system for use within the client application 202.

In addition, the message handler 212 can facilitate the sending of a payment from a sender to a recipient. In particular, FIG. 2 illustrates that the client application 202 can include a payment request generator 218 that can generate a payment request that the message handler 212 can send to the network application 204 to initiate a payment process/transaction. For example, upon a sender selecting a payment element on a user interface, the payment request generator 218 can create a data package that includes payment information received from the sender. A payment request can include an indication of an amount of money to be sent as part of the payment transaction as well as any necessary information to allow the network application to perform a payment transaction. According to one or more embodiments, the message handler 212 can communicate with the network application 204, as described in more detail below.

In one or more embodiments, the payment request generator 218 can create a data package that includes the payment amount, one or more sender identifiers, and one or more recipient identifiers, currency information, a message or payment description, and/or any other data that may be helpful to facilitate a payment from the sender to the recipient in accordance with the secure payment transaction process described in more detail below. Alternatively, a payment request can identify a recipient, an amount of a payment, and an offline reference that allows the client device 200a of a sender to resolve inconsistencies in data sent and received. The payment request generator 218 can pass the payment request (e.g., the data package that includes the payment information) to the message handler 212 to send to the network application 204.

The payment request generator 218 can also obtain payment information from various sources. For example, the payment request generator 218 can obtain payment information directly from the sender via the user input detector 210. Additionally, or alternatively, the payment request generator can gain access to payment information maintained on the client device 200a, 200b by the data manager 220. For example, the client application 202 can allow a sender to input and save various payment methods, financial systems or corresponding banking applications, and/or identify a default payment method, default currency, and otherwise specify other user preferences related to sending and/or receiving a payment.

The payment request generator 218 may also facilitate formatting of messages based on input from the user via the client application 202. Specifically, the payment request generator 218 can facilitate formatting payment requests according to the corresponding payment method. For example, the payment request generator 218 can determine that a user has input a request to pay a co-user via an ACH funds transfer and format of the payment request to the co-user accordingly. In one or more examples, the payment request generator 218 can determine that the payment request should be formatted in a particular format based on payment information or payment credentials associated with the payment transaction or based on a specific selection by the sending user.

As mentioned above, the client application 202 can further include a message analyzer 214. The message analyzer 214 can analyze messages sent from and received by the client application 202 for events or attachments. In one or more embodiments, the message analyzer 214 can identify events from contextual content in the exchanged messages. In one or more additional embodiments, the message analyzer 214 can identify a payment request based on an attachment or content in a message, the payment request containing information about a payment transaction.

The client application 202 can further include an application manager 216. The application manager 216 can access information associated with applications installed and/or running on the client device 200a. For example, the application manager 216 can access data stored on the client device 200a to determine whether one or more banking applications are installed on the client device 200a. The application manager 216 can identify applications based on storage locations or files stored on the client device 200a in connection with the applications. Alternatively, the application manager 216 can identify applications based on user input that indicates one or more particular applications.

Additionally, the application manager 216 can cause the client device 200a to communicate with and/or switch to another application on the client device in connection with a payment request. For example, the application manager 216 can identify a payment request and cause the client device 200a to switch to another application installed on the client device 200a (e.g., the banking application 203) to allow a sender user to authenticate with the payment network 115. The application manager 216 can also cause the client device 200a to switch back to the client application 202 after the user authenticates with the payment network 115.

As discussed above, the client device 200a can include a data manager 220, as illustrated in FIG. 2. The data manager 220 can maintain message data representative of data used in connection with composing, sending, and receiving messages between a user and one or more other users. For example, message data can include message logs, contact lists, content, past communications, past payment transactions, and other similar types of data that the client application 202 can use in connection with providing the ability for users to communicate using the client application 202.

The data manager 220 may also maintain payment data representative of information used to generate payment requests. For example, payment data may include payment preferences (e.g., a default payment method such as a checking account). Additionally, payment data can include alternative payment methods, as well as payment credential information for certain types of payment accounts. In general, payment data can include any data that the payment request generator 218 can use in connection with generating a payment.

In one or more embodiments, the banking application is an application that allows the user to interact with a corresponding bank system. Specifically, the banking application can be a third-party application (e.g., an application that the bank system publishes) that allows the user to perform one or more interactions associated with a payment account of the user. The user can log in to the user's payment account at the bank system using the banking application to manage the payment account. For example, the user can manage the payment account by viewing an account balance, withdrawing funds, depositing funds, setting up automatic payments or otherwise interacting directly with the payment account.

As briefly mentioned above, the payment system 102 can include a network application 204 that is implemented in whole or in part on the server device(s) 108. In one or more embodiments of the present disclosure, the network application 204 comprises, or is part of, a social networking system (such as but not limited to FACEBOOK™), but in other embodiments the network application 204 may comprise another type of application, including but not limited to an e-mail application, search engine application, or any number of other application types that utilizes user accounts.

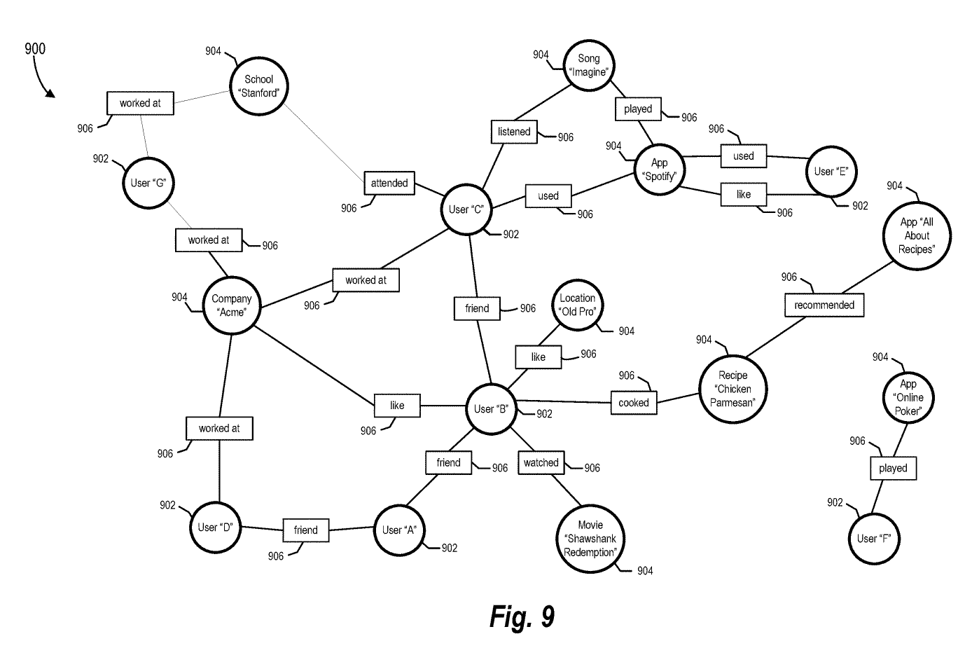

In one or more embodiments where the network application 204 comprises a social networking system, the network application 204 may include a social graph 250 for representing and analyzing a plurality of users and concepts. Node storage 252 of the social graph 250 can store node information comprising nodes for users, nodes for concepts, nodes for transactions, and nodes for items. Edge storage 254 of the social graph 250 can store edge information comprising relationships between nodes and/or actions occurring within the social networking system. Further detail regarding social networking systems, social graphs, edges, and nodes is presented below with respect to FIG. 9.

The communication manager 230 can process messages received from client applications 202. For example, the communication manager 230 can interact with a message handler 206 of a client application 202. The communication manager 230 can act as a director for messages sent back and forth among users in an electronic messaging thread. The communication manager 230 may receive a message from client application 202, detect the intended recipient of the message, and send the message to the client application 202 (or device) associated with the intended recipient.

Additionally, the communication manager 230 can also re-format or otherwise modify the content or format of a message based on the messaging protocol used by a destination communication device or a type. As such, in one or more embodiments the payment system 102 can allow participants using different communication platforms to exchange messages. For example, the communication manager 230 can receive a message in a first protocol (SMS, IM, XMPP, APNS, etc.), re-format the message into a second protocol, and send the reformatted message to the intended recipient(s).

The status manager 232 can track the status of users of the client applications 202 and/or the client devices 200a, 200b. For example, the status manager 232 can identify when a user is logged into the client application 202, when a user is active on the client application 202, when a client device 200a, 200b associated with a user or user account is online or active. The status manager 232 can send indications (such as push notifications) to the client application 202 to notify the client application 202 of the status of users, device, messages, or payments. The user interface manager 208 can add, modify, or otherwise change or update status notifications based on indications received from the status manager 232. For example, the status manager 232 can send an indication to the client application 202 indicating that another user has accessed a message, received a payment, sent a payment, is active, a device or device type a co-user is active on (e.g., mobile vs. web), etc. The user interface manager 208 in turn can update a user interface to notify a user of the status.

The network application 204 may also include a message database 234. The message database 234 can maintain message data representative of content of messages from electronic messaging sessions among a plurality of participants. The message database 234 may maintain status data representative of the information mentioned above that the status manager 232 tracks. The message database 234 can thus provide an archive of messaging threads, which the network application 204 can provide to a user on demand or once a user logs into the client application 202 using a new computing device.

The network application 204 can include a user profile database that allows the network application 204 to manage information about users of the networking system. For example, the user profile database can store profile information for user accounts. To illustrate, the user profile database can store personal information about the user that is available to the user and/or other users of the networking system. Additionally, the user profile database can store payment preferences and other payment profile information for a user.

In one or more embodiments, the network application 204 includes a risk calculator to facilitate risk checks of user accounts and payment transactions between user. Specifically, the risk calculator identifies information about a user that allows the network application 204 to make a determination whether the user is a fraudulent account, whether a particular payment transaction involving the user is a fraudulent transaction, or other fraud checks to protect the security of the networking system.

Additionally, the risk calculator can also perform additional operations associated with authenticating a user with a banking system in connection with a payment transaction. For example, as will be described in more detail below, the risk calculator can communicate with the social graph and/or the user profile database to identify information associated with a user's payment account at a financial system (e.g., the issuing bank system 122 of FIG. 1). To illustrate, the financial system can communicate with the payment engine and/or the network application to obtain information related to security questions that help the financial system authenticate the user when attempting to access the payment account.

As mentioned previously, the server device(s) 108 can include a payment engine 206 having a payment manager 240. The payment manager 240 of FIG. 2 can integrate the sending and receiving of payment requests and initiate payment transactions, and may employ one or more application programming interfaces (APIs). For example, upon the communication manager 230 receiving a payment request, the communication manager 230 can send any payment details to the payment manager 240. The payment manager 240 can then use the payment details retrieved from the payment request to initiate a payment transaction using the payment network 115.

According to one or more embodiments, the payment system 102 can maintain the payment engine 206 separate from the network application 204. For example, the payment system 102 can implement payment processes associated with the payment engine 206 separately from at least some of the functionality of the network application 204 (e.g., using a messaging database for recovery). To illustrate, the payment system 102 can implement the functionality of the payment engine 206 on a first group of one or more servers and the functionality of the network application 204 on a second group of one or more servers. Implementing functionality of the payment engine 206 and the network application on separate servers can allow the payment system 102 to ensure that at least some of the financial information associated with the users is maintained apart from the network application 204 to comply with Payment Card Industry (PCI) standards. Alternative configurations of servers and/or software than those described herein may also allow the payment system 102 to comply with PCI standards.

The payment manager 240 can coordinate a transaction corresponding to a payment defined in a payment request. As generally explained above, the payment manager 240 can coordinate a transaction via the payment network 115 that corresponds to a payment request, monitor the status of the transaction, and provide status information regarding the transaction. More specifically, the payment network 115 can authorize and fund a transaction in response to receiving the payment request, as described above with reference to FIG. 1. In one or more embodiments, the payment manager 240 can use one or more application programming interfaces (API) to communicate relevant information with the payment network 115.

In additional or alternative embodiments, the client application 202 on the client device 200a can cause the client device 200a to send a payment request and/or messages associated with the payment request to the network application 204 and the payment engine 206 in parallel. In particular, when the client application 202 receives a selection by the user to pay an amount to a co-user, the client application 202 can cause the client device 200a to send a payment request to the network application 204 and to the payment engine 206. Thus, the network application 204 can process the message including the payment request while the payment engine 206 is also processing the payment transaction associated with the payment request. In alternative embodiments, the client device 200a can send messages to one or more servers associated with the network application 204, which can then forward the messages to the payment engine 206, or vice versa.

To complete a transaction, the payment manager 240 communicates with the payment network 115 to process the transaction. The payment manager identifies payment information associated with the payment transaction (e.g., amount, recipient identifier) and sends the payment information to the payment network 115. Specifically, after the payment manager 240 receives the payment information, the payment manager 240 can identify the recipient. The payment manager 240 can lookup the recipient in the user profile database 236 to determine if the recipient has registered a banking account/token. At this point, the payment manager 240 can initiate the transaction.

In the event that the recipient's user profile does not include a registered banking account/token, the payment manager 240 can direct the communication manager 230 to send the recipient a message prompting the recipient register a banking account.

In one or more additional embodiments, the payment manager 240 can communicate with the risk calculator 238 to determine a risk associated with a sender, a recipient, and/or a particular payment transaction. Specifically, the risk calculator 238 can determine whether the sender/recipient is a fraudster based on information associated with the sender/recipient in order to prevent fraudulent payment transactions. For example, the risk calculator 238 can determine the likelihood of fraudulent activity based on activity or information associated with the sender/recipient in connection with the network application.

For example, in one or more embodiments, the network application 204 can determine whether a risk associated with the sender or the recipient satisfies a predetermined threshold. In particular, the network application 204 can determine whether the sender or the recipient (i.e., the lender or borrower depending on the transaction) is a fraudster (e.g., a scam account or software posing as a real person) based on a “realness” score. For example, if the risk associated with the sender is below a predetermined threshold (i.e., a high risk level), the network application 204 can determine that the sender is likely a fraudster and notify the payment engine 206 that the sender is a fraudster. If the sender has a high-risk level, the payment engine 206 can stop a payment transaction between the sender and the recipient. Similarly, if the risk associated with the recipient is below a predetermined threshold, the network application 204 can determine that the recipient is likely a fraudster and notify the payment engine 206 that the recipient is a fraudster.

In additional embodiments, the risk calculator 238 determines whether security information received from a financial system matches profile information or social graph information for a user of the networking application. Specifically, when a user attempts to authenticate with a financial system by providing login information or account information to the financial system, the risk calculator 238 can verify security information associated with the user payment account. For example, the risk calculator 238 can receive a request from the payment manager to verify one or more security questions/answers associated with the payment account and attempt to identify the answers in the social graph and/or the user profile for the user, as described in more detail below.

In one or more embodiments, upon receipt of a payment request from a sender, the payment manager 240 can detect the user (or group) ID of the sender and retrieve the payment profile for that user (or entity). The payment manager 240 can then generate a transaction package (e.g., a “payment drone”) that includes a transaction ID associated with a payment amount, the sender, and the recipient. The transaction ID can help the payment system 102 track money from the sender's account, within the system in a temporary or intermediate account, and to the recipient's account. In some instances, the payment system 102 can provide users access to the transaction ID to follow the movement of money during a corresponding payment transaction.

The transaction package can also include a default payment method, and related information, unless the sender selected to send a payment to the recipient with an alternative payment method, in which case the transaction package can include payment information for the alternative payment method. The payment manager 240 may then send the transaction package to the payment network 115 to initiate the payment authorization process.

The payment manager 240 can perform various other additional steps and methods in order to effectively manage the payment process. In one or more embodiments, for example, upon receiving a payment request the payment manager 240 can generate a transaction identifier (or simply “transaction ID”) and associate the transaction identifier with the payment request and/or the payment information within the payment request. For instance, upon generating a transaction ID, the payment manager 240 can send the transaction ID and the payment information to the transaction database 242. The transaction database 242 can include a data table or similar data matrix that stores transaction information according to transaction ID.

The transaction database 242 of FIG. 2 can provide storage for each transaction (such as in the form of a graph object), attempted or completed, the transaction ID, a date, an amount of the transaction, the payment method used, associated messages interchanged between sender and recipient related to the transaction, and any other information gathered on the transaction. With this information, the payment manager 240 can provide, upon request, a summary of one or more transactions to users as a history of payments requested, payments declined and payments completed.

In one or more embodiments, after a transaction ID is associated with a particular payment request, the transaction ID can be included or embedded within substantially all communications within the payment system 102 relating to the particular payment. As such, the transaction ID allows the payment manager 240 to manage and process a large number of payments in an organized fashion. For example, the payment manager 240 can include instructions to include the transaction ID in any information sent to the client devices 200a, 200b. In return, the messaging handlers 210 can also include the transaction ID in any information sent from the client devices 200a, 200b to allow the payment manager 240 to efficiently and reliably identify a particular transaction to which the information corresponds.

In one or more embodiments, the transaction ID can be associated with one or more sender identifiers, recipient identifiers, thread identifiers (e.g., identifying a messaging thread between the sender and the recipient), payment amounts, payment methods (e.g., sender accounts), deposit methods (e.g., recipient accounts), transaction history, current transaction status, as well as other transaction information. In one or more embodiments, the transaction database 242 maintains the transaction information in the form of one or more graph objects that are updated with any updates or actions with respect to a transaction.

As mentioned, the payment engine 206 can also include a token manager 246. The token manager 246 can manage tokens associated with users of the social networking system in relation to payment accounts of the users. Specifically, the token manager 246 can manage tokenized credentials for users who have previously engaged in payment transactions with one or more other users via the social networking system. For example, after a user engages in a payment transaction with at least one other user, the issuing financial system can send a tokenized credential containing identity information or account information tied to the user's payment account at the financial system. Additionally, the tokenized credential may not expire, and may not be affected by changes to the account number or other aspects of the account, such that the token manager 246 can store and use the token indefinitely.

In one or more embodiments, if a user engages in a payment transaction using a payment account at the financial system, the financial system can send a token including the identity information or the account information to the payment engine 206. The token manager 246 can use the token for future payment transactions to more quickly process the payment transactions. In particular, the token manager 246 can send the token to the payment network 115 in connection with a payment transaction without a sender user manually providing additional account information to the payment network 115.

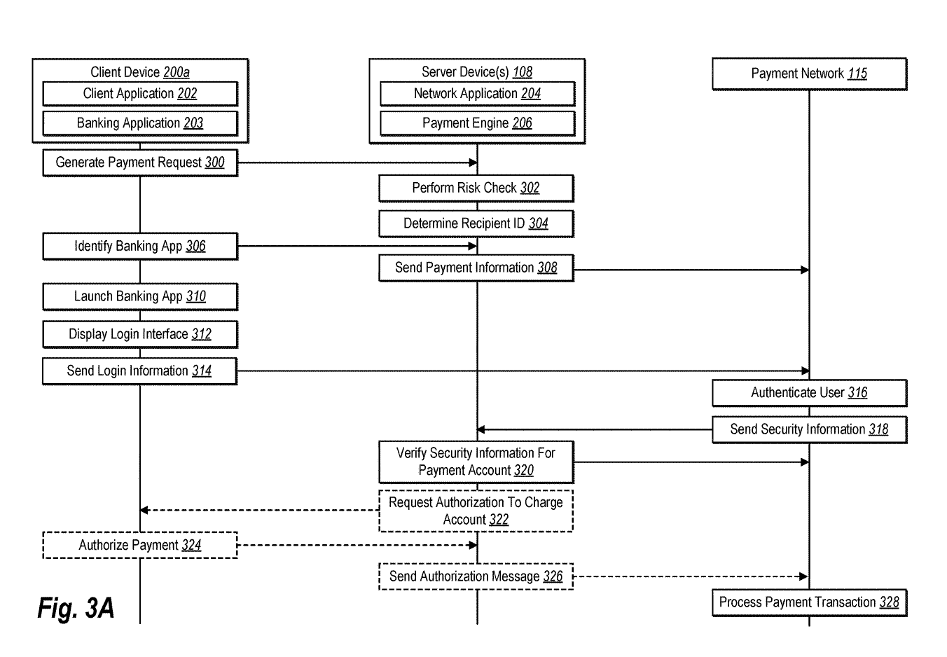

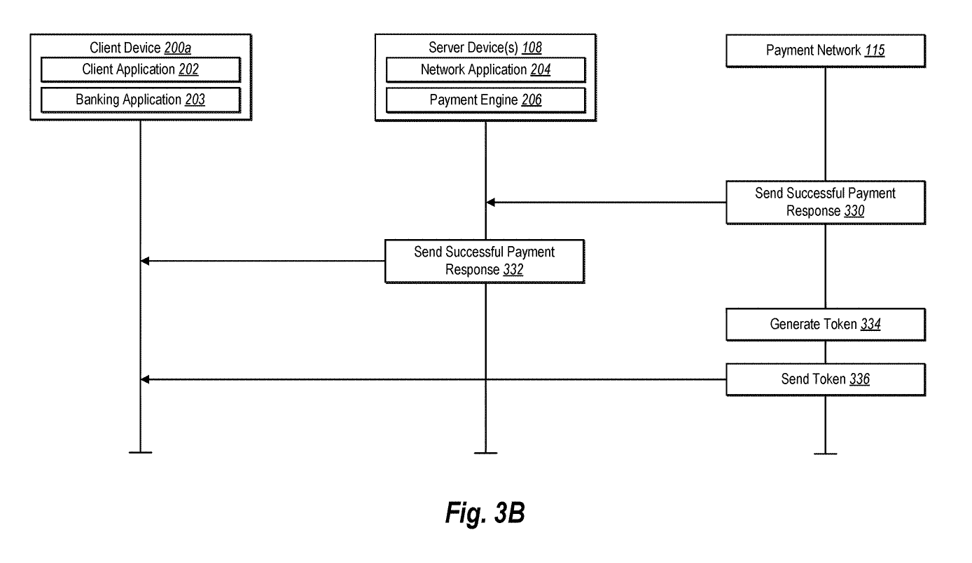

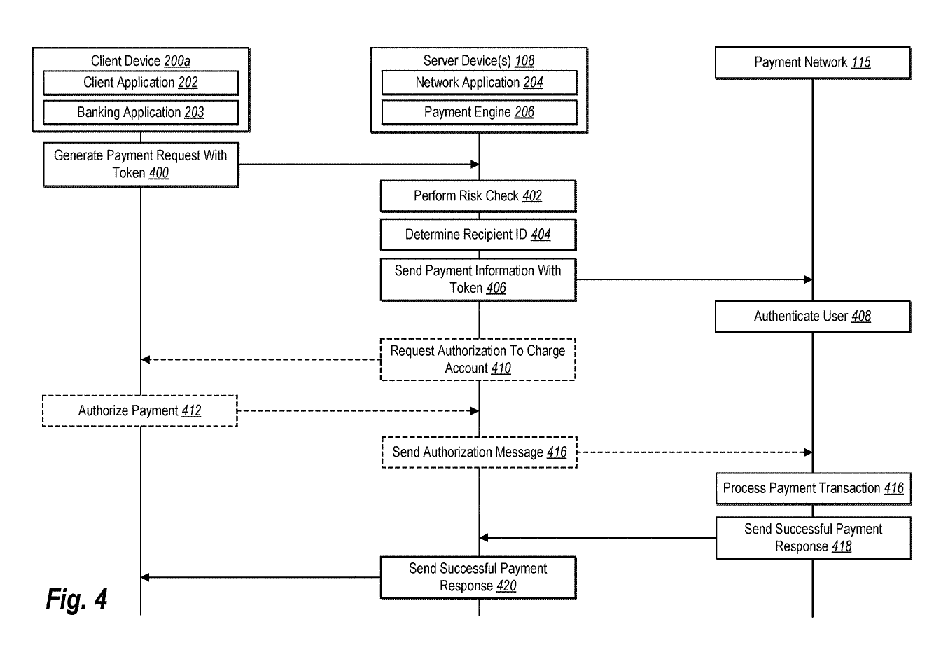

As discussed, the systems and components discussed above with reference to FIGS. 1-2 can allow users of a social networking system to easily, effectively, and securely engage in payment transactions via a payment system 102. FIGS. 3A-3B and FIG. 4 illustrate example process diagrams of one or more example embodiments of processes implemented by the payment system 102 discussed above. Consistent with the payment system 102 illustrated in FIGS. 1 and 2, FIGS. 3A-3B and FIG. 4 illustrate (according to a sequence flow of operations) a client device 300a including a client application 202 and a banking application 203, server device(s) 108 that support a network application 204 and a payment engine 206, and a payment network 115.

In one or more embodiments, a process for a sender user initiating a payment transaction with a recipient user begins with the client device generating 300 a payment request in response to the sender requesting to initiate a payment transaction with the recipient and send the payment request to the server device(s) 108. For example, the client device can generate a payment request in response to the sender selecting an option in a user interface to pay a recipient. The client device can format the payment request to indicate to the payment engine to process the payment transaction in accordance with the payment transaction type. In one or more embodiments, the client device can format the payment request to indicate that the payment transaction is an ACH payment or other direct withdrawal from the sender's payment account.

In response to the request to initiate the payment transaction, the server device(s) 108 can optionally perform 302 a risk check for the requested payment transaction. For example, the network application 204 can use information associated with the sender, the recipient, and/or the relationship between the sender and the recipient to determine whether to process the payment transaction based on the associated risk. Specifically, the network application 204 can determine a risk associated with the sender and/or recipient and notify the payment engine 206 of the risk. Although FIG. 3A illustrates the risk check at a particular point during the processing of the payment transaction, the risk check may occur at any time before processing the payment transaction.

Additionally, the server device(s) 108 can determine 304 a recipient ID associated with the recipient. In particular, the network application 204 can analyze the payment request to determine the recipient of the payment transaction. The recipient has an associated recipient ID that is unique to the recipient, allowing the payment network 115 to process the payment transaction between the sender and the recipient.

In one or more embodiments, after sending the payment request to the server device(s) 108, the client device 200a can identify 306 a banking application. Specifically, the client application can identify one or more banking applications installed on the client device 200a. For example, the client device 200a can include a banking application associated with a financial system at which the sender has a payment account. The banking application can be a mobile application installed on a mobile device (i.e., client device 200a) of the sender. The client application can include a mobile networking application that identifies the banking application based on a location of the banking application on the mobile device.

In one or more embodiments, the client application prompts the sender to select a banking application from a plurality of banking applications installed on the client device 200a. In particular, if the client application identifies a plurality of banking applications installed on the client device, the client application can display the banking applications in an interface from which the sender can select a banking application. Alternatively, the sender can manually input a banking application or corresponding financial system. In still further embodiments, when no banking application is installed, the client application can prompt the user to select and install a banking application.

After identifying a banking application, the client application can send the payment engine 206 an indication of the identified banking application. Additionally, the server device(s) 108 can determine a financial system associated with the banking application and send 308 the payment information (e.g., a payment amount and recipient identifier) associated with the payment transaction to the financial system at the payment network 115. For example, the payment engine 206 can identify the financial system based on a bank identifier associated with the banking application and send the payment information to the financial system. To illustrate, the payment engine 206 can send a uniform resource identifier associated with the payment information to the financial system. The financial system can acknowledge the received payment information and store the payment information to process the payment transaction after authenticating the user, as described below.

In one or more embodiments, the client application causes the client device to launch 310 the banking application or a specified function of the banking application. Specifically, the client application can locate the banking application on the client device and cause the client device to launch the banking application or the specified function. For example, the client application can cause the client device to do an app switch from the client application to display 312 a login interface of the banking application. Alternatively, the client application can cause the client device to display a login interface from the banking application within the client application (e.g., within an iframe).

In alternative embodiments, the client application can include a web application running in a web browser. The client application can prompt the user to identify a banking application or a financial system for processing the payment transaction. For example, the client application can cause the web browser to open a new tab or window to a website associated with the financial system. To illustrate, the client device can display a login page for the financial system in the new tab or window.

The sender can then enter login information or other authentication information into the login interface displayed at the client device. For example, the sender can enter a username and a password for the payment account into the login interface. The client device can then send 314 the login information to the payment network 115 for authenticating the user with the payment account.

The financial system can authenticate 316 the user for the payment account based on the login information. For example, the financial system verifies that the sender is an owner of the payment account by checking the provided login information against stored login information for the payment account. Authenticating the user for the payment account allows the financial system to process the payment transaction using the payment account by funding the payment transaction for the payment amount previously provided to the financial system.

In one or more embodiments, the financial system can require that one or more security questions be answered prior to granting access to the payment account. Specifically, financial systems often require users to enter answers to security questions selected by the user the first time the user logs in to the payment account on a given client device. The security questions provide an additional layer of security in case a user's login information is compromised. The security questions can deal with names, addresses, or other information that the sender would know.

The payment network 115 can send 318 security information associated with the payment account to the server device(s) 108. In particular, the payment network 115 can send the security information to the network application 204 to compare against information stored in the user profile database or the social graph. The security information can include the security questions and the security answers. Alternatively, the security information can include only the security answers.

After receiving the security questions, the network application 204 can verify 320 the security information for the payment account by comparing the security information to information associated with the user profile database and/or the social graph. If the network application 204 determines that at least some of the information in the user profile database and/or the security graph matches the security information from the payment network 115, the network application 204 can notify the payment network 115 that the sender likely corresponds to the owner of the payment account. If the network application 204 determines that none of the security information in the user profile database and/or the security graph matches the security information from the payment network 115, the network application 204 can notify the payment network 115 that the sender likely does not correspond to the owner of the payment account. In one or more embodiments, verifying the security information reduces costs associated with the payment transaction due to the reduced risk and less need for increased security measures.

Optionally, the server device(s) 108 can also request 322 authorization to charge the payment account from the sender. Specifically, the network application 204 can send a message to the client device requesting authorization from the sender, causing the client device to display a message requesting authorization to complete the payment transaction. Alternatively, the client application on the client device can provide the message to the user requesting authorization without the server device(s) 108 sending the request to the client device. The sender can authorize 324 the payment, causing the client device to send a payment authorization message back to the network application 204. The network application 204 then sends 326 an authorization message to the payment network 115 to indicate to the payment network 115 to complete the payment transaction using the payment account authenticated for the sender. The authentication by the sender can allow the sender to verify the payment transaction and to help prevent accidental payment transactions.

After verifying the security information, or after the sender authorizes payment, the payment network 115 processes 328 the payment transaction. For example, the financial system funds the payment transaction by withdrawing the payment amount from the payment account of the sender. To illustrate, the financial system can transfer the funds from the payment account of the sender to a payment account of the recipient by a direct debit transaction such as an ACH transaction. In one or more embodiments, the financial system associated with the payment account of the sender sends a message to the recipient requesting that the recipient accepts the payment.

After successfully processing the payment transaction, the payment network 115 can generate and send 330 a response to the network application 204 at the server device(s) 108, as illustrated in FIG. 3B. For example, the payment network 115 can send a successful payment response indicating that the payment process was completed successfully. The server device(s) 108 can then send 332 the successful payment response to the client device. The client device can also display the successful payment response in an interface of the client application.

In one or more embodiments, the payment network 115 generates 334 a token associated with the payment account of the sender. The payment network 115 then sends 336 the token to the client device. The payment network 115 may generate the token and send the token with the successful payment response or at any time after authenticating the sender. As previously mentioned, the token can be a tokenized credential that includes account information for authenticating the sender with the payment account. The token allows the client device to authenticate the sender with the payment network 115 without requiring the sender to authenticate by entering the login information. The token also allows the payment network 115 to authenticate the sender without re-verifying the security information.

In one or more alternative embodiments, the payment system 102 requires authentication of the sender with the payment account for each payment transaction. Specifically, the payment network 115 may process the payment transaction without generating a token to send to the client device. For example, the payment network 115 can require the sender to enter the login information at the login interface of the banking application each time the sender attempts to initiate a payment transaction via the client application.

As mentioned, the payment network 115 can generate a token for use in connection with additional payment transactions after a first payment transaction. FIG. 4 illustrates a process diagram of an example embodiment of a payment transaction using a token. In one or more embodiments, a process for the sender of FIGS. 3A-3B to initiate a payment transaction with a recipient user begins with the client device generating 400 a payment request with a token in response to the sender requesting to initiate a new payment transaction with a recipient and send the payment request to the server device(s) 108. For example, the client device can generate a payment request in response to the sender selecting an option in a user interface to pay a recipient. The client device can format the payment request to indicate to the payment engine to process the payment transaction in accordance with the payment transaction type. In one or more embodiments, the client device can format the payment request to indicate that the payment transaction is an ACH payment or other direct withdrawal from the sender's payment account.

In one or more embodiments, the client device stores the token in a predetermined location based on the client application. For example, the client device can store the token in a location that the client application is able to access when the sender initiates the payment transaction within the client application. The client application can locate the token and send the token to the payment engine 206 of the server device(s) 108. As mentioned, the token can be encrypted so that the token is secure while stored on the client device and while being transferred from the client device to the payment engine 206.

In response to receiving the token with the request to initiate the payment transaction, the server device(s) 108 can perform 402 a risk check for the requested payment transaction. For example, the network application 204 can use information associated with the sender, the recipient, and/or the relationship between the sender and the recipient to determine whether to process the payment transaction based on the associated risk. Specifically, the network application 204 can determine a risk associated with the sender and/or recipient and notify the payment engine 206 of the risk. In one or more embodiments, if the network application 204 has previously performed a risk check for the sender, the network application uses the previous risk check for the sender. Alternatively, the network application 204 can perform a new risk check or update the previous risk check with new information.

Additionally, the server device(s) 108 determine 404 a recipient ID associated with the recipient. In particular, the network application 204 can analyze the payment request to determine the recipient of the payment transaction. After identifying the recipient ID, the server device(s) 108 send 406 the payment information (i.e., payment amount, recipient ID) with the token to the payment network 115. Because the sender has already engaged in a payment transaction and has a token, the payment engine 206 can send the payment information and the token to the payment network 115 without identifying the banking application and the financial system associated with the payment account.

The financial system can authenticate 408 the user for the payment account based on the login information or other account information included in the token. For example, the financial system verifies that the sender is an owner of the payment account by decrypting the token and compared the contents of the token to stored information at the payment network 115. After decrypting the token, the payment network 115 authenticates the sender user for the payment account.

Optionally, the server device(s) 108 can also requests 410 authorization to charge the payment account from the sender. Specifically, the network application 204 can send a message to the client device requesting authorization from the sender, causing the client device to display a message requesting authorization to complete the payment transaction. The sender can authorize 412 the payment, causing the client device to send a payment authorization message back to the network application 204. The network application 204 then sends 414 an authorization message to the payment network 115 to indicate to the payment network 115 to complete the payment transaction using the payment account authenticated for the sender. The authentication by the sender can allow the sender to verify the payment transaction and to help prevent accidental payment transactions.

After verifying the security information, or after the sender authorizes payment, the payment network 115 processes 416 the payment transaction. For example, the financial system funds the payment transaction by withdrawing the payment amount from the payment account of the sender. To illustrate, the financial system can transfer the funds from the payment account of the sender to a payment account of the recipient by a direct debit transaction such as an ACH transaction. In one or more embodiments, the financial system associated with the payment account of the sender sends a message to the recipient requesting that the recipient accept the payment.

After successfully processing 418 the payment transaction, the payment network 115 can generate and send a response to the network application 204 at the server device(s) 108. For example, the payment network 115 can send 420 a successful payment response indicating that the payment process was completed successfully. The server device(s) 108 can then send the successful payment response to the client device. The client device can also display the successful payment response in an interface of the client application.

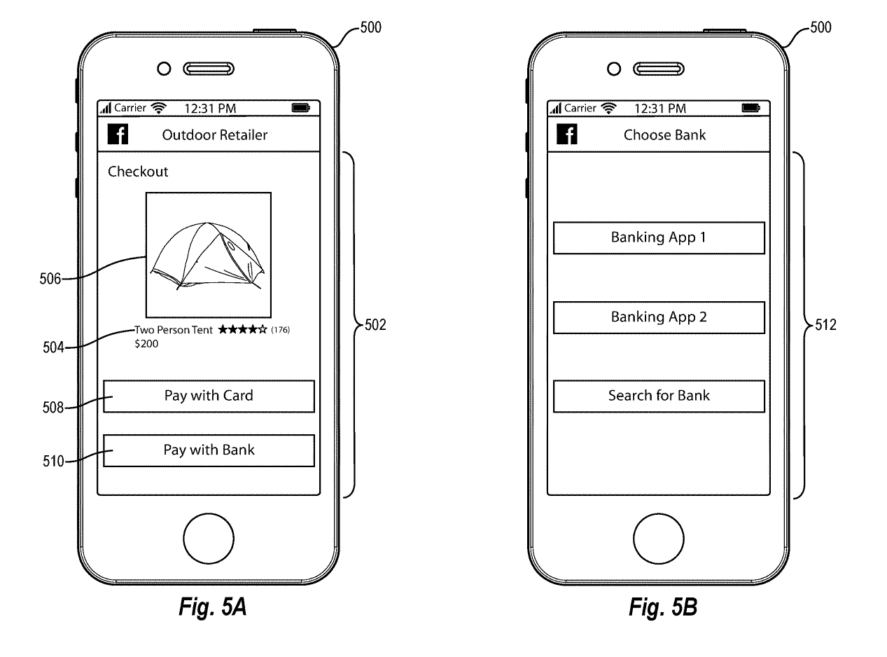

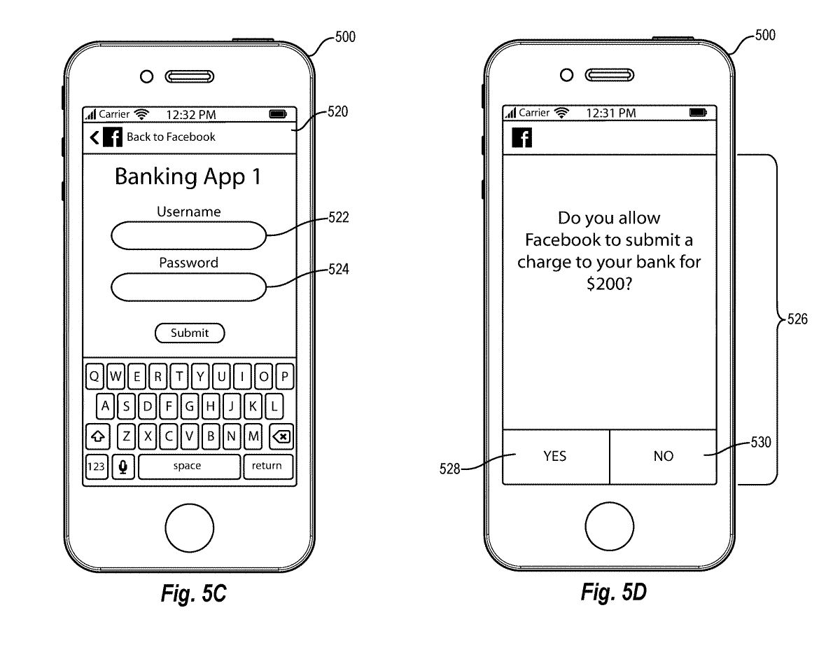

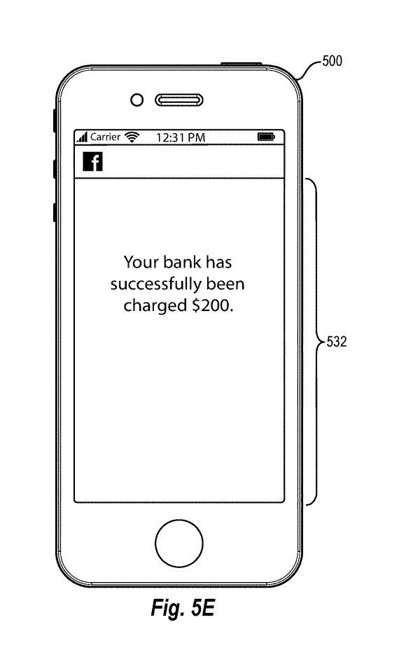

As will be described in more detail below, the components of the environment and payment system 102 as described with regard to FIGS. 1-4, can provide, along and/or in combination with the other components, one or more graphical user interfaces. In particular, the components can allow a user to interact with a collection of display elements for a variety of purposes. In particular, FIGS. 5A-5E and the description that follows illustrate various example embodiments of the user interfaces and features that are in accordance with general principles as described above.

For example, FIGS. 5A-5E illustrate various views of GUIs provided by the client application to facilitate sending and receiving payments. A client device running the client application can implement part of the payment system 102, as previously described. For example, FIG. 5A illustrates a client device 500 that may implement one or more of the components of the client device 200a. As illustrated in FIG. 5A, the client device 500 is a handheld device, such as a mobile phone device (e.g., a smartphone). As used herein, the term “handheld device” refers to a device sized and configured to be held/operated in a single hand of a user. In additional or alternative example, however, any other suitable computing device, such as, but not limited to, a tablet device, a handheld device, larger wireless devices, laptop or desktop computer, a personal-digital assistant device, and/or any other suitable computing device can perform one or more of the processes and/or operations described herein.

The client device 500 can include the features and components described below in reference to a computing device 700 of FIG. 7. As illustrated, the client device 500 includes a touchscreen that can display or provide user interfaces, and by which user input may be received and/or detected. As used herein, a “touchscreen display” refers to the display of a touchscreen device. In one or more embodiments, a touchscreen device may be a client device with at least one surface upon which a user may perform touch gestures.

As previously noted, the payment system 102 allows users to engage in payment transactions with other users by way of a networking system (e.g., a social networking system). In one or more embodiments, the client application is a networking application that causes the client device to communicate with the networking system. For example, the client device 500 can communicate with the networking system to provide networking information within the client application. To illustrate, the networking information can include information about other users of the networking system, such as messages composed by other users or bio information about other users.

In one or more implementations, the networking information includes product or service information from a merchant user. In particular, the merchant user can manage a merchant page within the networking system to provide information about the merchant user and its products to users of the networking system. The merchant page can also allow the merchant user to interact with other users of the networking system. Alternatively, the merchant can manage a website or be associated with a website that integrates with the networking system (e.g., by way of a user logging in using the account information for the networking system) to allow customers to purchase products from the merchant using a payment process via the networking system.

According to at least some embodiments, the merchant page displays product listings that a user may browse via the networking application. For example, the user can search for products, view products by category, etc., to identify a product in which the user is interested. The user can then select to purchase the product, for example, by placing the product in a virtual shopping cart. Additionally, the user can complete a purchase of the product by selecting a checkout option within the networking application.

FIG. 5A illustrates a checkout interface 502 associated with a merchant page in the networking application that allows the user to initiate a payment transaction to purchase a product. Specifically, the checkout interface 502 can display the contents of a shopping cart associated with the user. For example, the checkout interface 502 can determine the contents of the user's shopping cart based on information that the networking system stores in a user account for the user. To illustrate, when the user selects an option to add a product from a product listing to the user's shopping cart, the networking system can add an indication in the user account that the user has the product in the user's shopping cart.

The checkout interface 502 can also display additional information associated with the product in the shopping cart. For example, the checkout interface 502 of FIG. 5A displays a product name 504 that identifies the product and an image 506 of the product. The checkout interface 502 can also display a price (or payment amount) for the product as set by the merchant. Additionally, the checkout interface 502 can display other information about the product, such as product review information, a product identifier (e.g., a serial number or SKU for the product), items related to the product (e.g., items frequently viewed or purchased with the product).

In one or more embodiments, the checkout interface also displays one or more options of payment methods for purchasing the product. To illustrate, the checkout interface 502 of FIG. 5A includes payment method elements for purchasing the product using different payment methods. For example, a first element 508 corresponds to a card payment method. The card payment method can correspond to a credit card, debit card, gift card, cash card, or other card that allows the user to transfer funds to the merchant in a payment transaction to purchase the product. Such methods may require the user to enter card information to provide to the networking system, including a card number and a card code verification number. Additionally, card payment methods may require the user to enter billing information such as a name and an address of the user. In at least some embodiments, the checkout interface does not include an option to pay with a card.

The checkout interface also includes a second element 510 to pay with a bank (e.g., a direct debit payment method) as described previously. The direct debit payment method does not require the user to provide any account information to the networking system. Rather, the direct debit payment method allows the user to purchase the product by directly debiting the payment amount from a payment account of the user and crediting a payment account of the recipient. Thus, selecting the element 510 to pay with a bank allows the user to pay with a checking account or a savings account.

To process the payment transaction associated with the product purchase in response to the user selecting the option to pay with a bank, the payment system 102 first identifies a financial system. The payment system 102 can identify the financial system in a variety of ways. For example, the payment system 102 can allow a user to select the financial system in connection with a banking application on the client device, from a listing of financial system options, or by manual entry of a financial system.

FIG. 5B illustrates a bank selection interface 512 that provides a plurality of options for selecting different banking applications. In one or more embodiments, the client application determines the different banking applications based on whether the banking applications are installed on the client device. For example, the client application can determine that a first banking application and a second banking application are installed on the client device and displays. Each of the banking applications may correspond to a different financial system, with each financial system corresponding to a different payment account for the user.

According to one or more embodiments, the client application identifies the banking applications by examining a storage device of the client device. For instance, the client application can determine whether a particular banking application is installed on the client device based on the storage location of the banking application. Alternatively, the client application can determine that the banking application is installed on the client device based on session information associated with an instance of the banking application running on the client device, or for the most recent instance of the banking application.

In yet another example, the client application can identify whether a banking application is installed on a client device based on information at server device(s) (e.g., the server device(s) 108 of FIG. 1) received from a plurality of financial systems. Specifically, the server device(s) 108 can communicate with a plurality of participating financial systems to determine possible locations of the banking applications in different operating systems. For example, a banking application may install at the same, fixed location for a given operating system. Thus, the client application can communicate with the server device(s) to identify whether any banking applications are stored at the fixed locations corresponding to a plurality of financial systems.

After identifying the different banking applications on the client device, the client application can display options to select a banking application to use in a payment transaction. For example, FIG. 5B illustrates a plurality of selectable elements 514, 516 that indicate a plurality of different banking applications. When the user selects one of the plurality of selectable elements 514, 516, the client application can determine a financial system corresponding to the banking application for the payment transaction.

Alternatively, the user can select a selectable element 518 that allows the user to choose a financial system manually. For example, the “Search for Bank” element can cause the client application to display a listing of different financial systems from which the user may choose a financial system where the user has a payment account. In another example, the client application can display a text field in which the user can manually type in a financial system. The client application can recognize the manually entered financial system and select the financial system that matches the user input. In one or more embodiments, the client application prompts the user to enter a financial system if the client application detects no banking applications on the client device.

In one or more alternative embodiments, the client application can first determine the financial system based on a selection by the user. The client application can then determine whether a banking application for the financial system is installed on the client device by requesting an installation location of the banking application from the financial system and receiving a response from the financial system. Thus, the client application can identify the location of the banking application based on the selection of the financial system by the user instead of determining the financial system based on the installed banking applications.

Additionally, after determining the financial system and identifying the banking application, the client application can establish a communication link between the client application and the banking application. In particular, establishing a link between the client application and the banking application allows the client application to launch the banking application and/or access portions of the banking application during the payment transaction. For example, the client application can request and receive a parameter from the banking application to perform app switching between the client application and the banking application on the client device. Alternatively, the client application can perform app switching by leveraging capabilities of an operating system of the client device.

In one or more embodiments, after identifying the financial system, the client application sends payment information for the payment transaction to the financial system. For example, the client application can cause the client device to send the payment amount and a recipient identifier (e.g., a merchant ID) to the financial system. The client application can send the payment information to the financial system so that the financial system can prepare to process the transaction upon authenticating the user.

Furthermore, after identifying the financial system, the client application switches to a login interface of the previously identified banking application. FIG. 5C illustrates a login interface 520 for the banking application in connection with the payment transaction. In one or more embodiments, the client application switches to the banking application to display the login interface. Alternatively, the client application can display the login interface 520 for the banking application within the client application (e.g., within an iframe). As previously mentioned, the client application can alternatively be implemented within a web browser, and the client application can cause the login interface 520 for the financial system to display in another tab or window of the web browser.

As illustrated, the login interface 520 includes a username field 522 for the user to enter a username and a password field 524 for the user to enter a password. The user can enter the username and the password corresponding to the user's payment account with the financial system. The client sends the login information to the financial system, and the financial system can authenticate the user based on the provided login information without the client application or the server device(s) 108 of the networking system ever receiving the login information. If the user is already logged in to the banking application prior to initiating the payment transaction in the client application (e.g., the client device has current session information for an instance of the banking application), the financial system can use the current session information for authenticating the user's login information.

As part of the authentication process, one or more embodiments of the payment system 102 require the server device(s) 108 to verify security information associated with the user's payment account. Specifically, as previously mentioned, some financial systems require users to choose security questions to protect their payment accounts. A user selects the security questions and enters answers for the security questions that the financial system stores. When the user attempts to log in to the payment account with the login information (e.g., on a new client device), the financial system requires that one or more security questions be answered prior to authenticating the user.

For example, when setting up the payment account, a security question may ask a user to enter a childhood nickname, a friend, a previous address, a grandparent's name, a car model or color, a job, place, or other information that only the user or someone close to the user is likely to know. In one or more embodiments, after receiving and verifying the login information with a payment account, the financial system can access one or more security questions associated with the payment account. According to various embodiments, the financial system accesses all of the security questions or only some of the security questions associated with the payment account.

The financial system can then send the selected security questions and answers (or just the answers) to the server device(s) 108 to allow the networking system to determine whether any of the information stored in the user profile database or social graph corresponds to the provided security information. To illustrate, if a security question for the payment account asks, “What is your maternal grandmother's first name?” the networking system can view the user's social graph to identify if the user has a social connection that matches the corresponding answer to the security question. If the security information received from the financial system matches the user profile information or social graph information, the server device(s) 108 can verify the security information to the financial system. Because the server device(s) 108 handle verification of the security information, the user does not see the process of verifying the security information. Alternatively, the server device(s) 108 can notify the financial system that the networking system was unable to verify the security information, at which point the financial system may require the user to answer a security question.

In at least one alternative embodiment, the financial system sends a plurality of answers to a plurality of questions to the server device(s) 108. The networking system can then compare the plurality of answers to information in the user profile database and/or the social graph. If the networking system can match a number of answers that meets a predetermined threshold to the information in the user profile database and/or the social graph, the networking system verifies the security information with the financial system. The predetermined threshold can be determined by the financial system or by the networking system.

In one or more embodiments, the networking system can request authorization from the user to process the payment transaction. FIG. 5D illustrates an authorization interface 526 with a message requesting authorization from the user. The user can select to authorize or reject authorization within the authorization interface 526, for example, by selecting an accept element 528 (“YES”) or a reject element 530 (“NO”). Requiring authorization from the user can help prevent the user from accidentally purchasing a product or accidentally entering into a payment transaction. Although FIG. 5D illustrates the authorization interface 526 after the user logs in to the financial system, the client application can request authorization at any time after the user selects an option to initiate the payment transaction. For example, the client application may request authorization before displaying the login interface 520 of the banking application.

When the user selects an option to authorize the payment, or after authenticating the user with the financial system, the financial system processes the payment transaction to debit funds from the user's payment account. Specifically, the financial system transfers the funds from the user's payment account to a payment account of the recipient (e.g., the merchant) based on the payment information that the server device(s) 108 previously passed to the financial system in response to identifying the financial system and/or launching the banking application. If the financial system encounters no problems processing the payment transaction, the financial system can notify the server device(s) 108 of the successful payment transaction. The server device(s) 108 can then send a message to the client device indicating the successful payment transaction. For example, FIG. 5E illustrates a completion message 532 indicating the successful completion of the payment transaction. If the financial system encounters problems processing the payment transaction (e.g., insufficient funds or other error), the financial system can send a notification that the payment transaction was canceled.

As previously described, in subsequent payment transactions, the client application may not perform app switching to the login interface 520 of the banking application. In particular, the client application may receive a token from the financial system to authenticate the user with the financial system. For example, the token may allow the financial system to identify the user and the corresponding payment account for processing payment transactions without requiring the user to enter any login information. Thus, the client application would not need to switch to the login interface 520 of the banking application and could simply request authorization from the user. The client application could then send the payment information with the token to the server device(s) 108, which would then pass the payment information and the token to the financial system to process the payment transaction.

Additionally, after processing the first payment transaction, the client application may set the selected financial system/payment method as the default payment method. Thus, for future payment transactions, the client application may not require the user to select the banking application or the financial system, but may use the stored default settings. The client application may provide an option to change the default setting or to temporarily use a different payment account or payment method.

In one or more alternative embodiments, the financial system or the client application may require user authentication each time the user sends a payment request to initiate a payment transaction. Specifically, the financial system may not send a token to the client device for use in future payment transactions. Each time the user attempts to initiate a payment transaction, the client application app switches to the login interface of the banking application to authenticate the user, and the financial system proceeds to process the payment transaction.

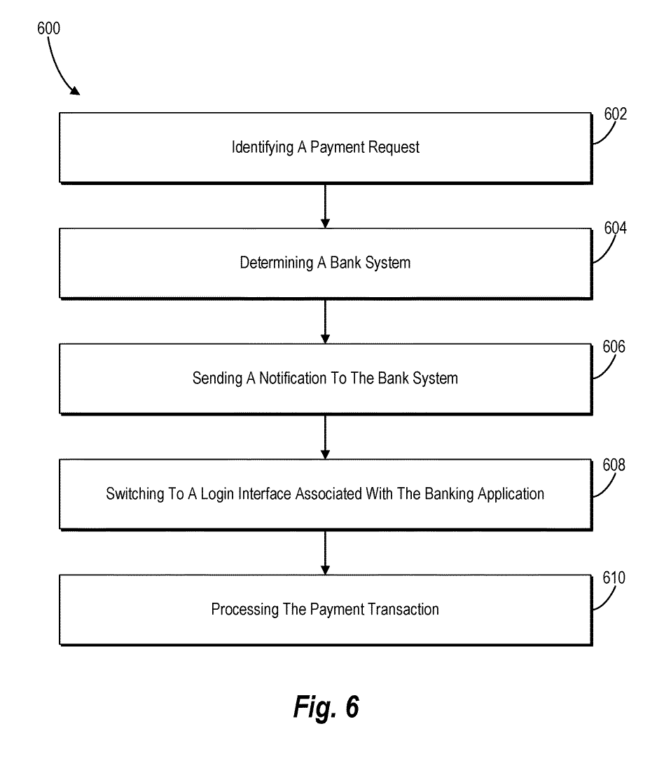

FIGS. 1-5E, the corresponding text, and the examples, provide a number of different systems and devices for sending and receiving payments in an electronic payment system. In addition to the foregoing, embodiments can be described in terms of flowcharts comprising acts and steps in a method for accomplishing a particular result. For example, FIG. 6 illustrates a flowchart of an exemplary method in accordance with one or more embodiments.

FIG. 6 illustrates a flowchart of a method of processing secure electronic payment transactions. The method 600 includes an act 602 of identifying a payment request. For example, act 602 involves identifying a payment request by a user 104a to initiate a payment transaction with a recipient via a networking application 202 on a client device 106a, 200a. To illustrate, act 602 can involve identifying a payment request by a user to initiate a payment transaction with a merchant to purchase a product available on a merchant page of a networking system. Alternatively, act 602 can involve identifying a payment request by a user to initiate a payment transaction with a co-user of a networking system within a messaging thread.

The method 600 also includes an act 604 of determining a financial system. For example, act 604 involves determining a bank system 122 corresponding to a banking application 203 installed on the client device 106a, 200a, the bank system 122 associated with a payment account of the user. Act 604 can involve identifying a plurality of banking applications installed on the client device 106a, 200a, and displaying the plurality of banking applications in the network application 204. Additionally, act 604 can involve receiving a selection of a banking application 203 from the plurality of banking applications.

Act 604 can involve receiving a user selection of the financial system in the networking application 202, and sending a request to the bank system 122 for an installation location of the banking application. Act 604 can further involve receiving a response from the bank system 122 indicating the installation location of the banking application, and locating the banking application 203 on the client device 106a, 200a based on the response from the banking application 203.

Alternatively, act 604 can involve detecting a selection of the banking application 203 installed on the client device 106a, 200a, and determining the bank system 122 based on the selected banking application 203. For example, act 604 can involve identifying a bank ID from the banking application 203, and determining the bank system 122 based on the identified bank ID.

The method 600 further includes an act 606 of sending a notification to the financial system. For example, act 606 involves sending a notification of the payment request to the financial system, the notification comprising a payment amount and a recipient identifier associated with the payment request. Act 606 can involve sending the notification to the bank system 122 in response to determining the bank system 122 corresponding to the banking application 203 installed on the client device 106a, 200a.

Additionally, the method 600 includes an act 608 of switching to a login interface 520 associated with the banking application 203. For example, act 608 involves performing an app switch to a login interface 520 associated with the banking application 203, the login interface 520 requesting login information for the payment account of the user 104a.

As part of act 608, or as an additional act, the method 600 can include an act of detecting that the user 104a has entered the login information in the login interface 520. The method 600 can further include performing an app switch back to the networking application 202 from the login interface 520 of the banking application in response to the user 104a entering the login information in to the login interface 520.

The method 600 also includes an act 610 of processing the payment transaction. For example, act 610 involves processing the payment transaction using the payment account of the user using an authorization from the bank system 122, the authorization based on the user logging into the payment account via the banking application 203 on the client device 106a, 200a.

As part of act 610, or as an additional act, the method 600 can include providing an authorization interface 526 in the client application to the user in response to the user entering the login information in to the login interface 520. The method can include receiving authorization from the user in the authorization interface 526, and sending an authorization message to the bank system 122 to complete the payment transaction.

As part of act 610, or as an additional act, the method 600 can include receiving security information from the bank system 122 in connection with the user entering the login information in to the login interface 520. The method 600 can also includes determining that the security information matches user account information in a networking system, the networking system corresponding to the networking application 202. For example, the method 600 can include identifying a security question from the security information, determining that the user account information in the networking system comprises an answer to the security question, and verifying the security information to the bank system 122.

The method 600 can also include an act of receiving a tokenized credential from the bank system 122 in response to the processed payment transaction, the tokenized credential corresponding to the payment account of the user 104a. Additionally, the method 600 can include identifying a second payment request by the user 104a to initiate a second payment transaction via the networking system. The method 600 further includes sending the tokenized credential with the second payment request to the bank system 122, and processing the second payment transaction using the payment account of the user using an authorization from the bank system 122, the authorization based on the tokenized credential.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. In one or more embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 7 illustrates a block diagram of exemplary computing device 700 that may be configured to perform one or more of the processes described above. One will appreciate that one or more computing devices such as the computing device 700 may implement the payment system 102. As shown by FIG. 7, the computing device 700 can comprise a processor 702, a memory 704, a storage device 706, an I/O interface 708, and a communication interface 710, which may be communicatively coupled by way of a communication infrastructure 712. While an exemplary computing device 700 is shown in FIG. 7, the components illustrated in FIG. 7 are not intended to be limiting. Additional or alternative components may be used in other embodiments. Furthermore, in certain embodiments, the computing device 700 can include fewer components than those shown in FIG. 7. Components of the computing device 700 shown in FIG. 7 will now be described in additional detail.

In one or more embodiments, the processor 702 includes hardware for executing instructions, such as those making up a computer program. As an example and not by way of limitation, to execute instructions, the processor 702 may retrieve (or fetch) the instructions from an internal register, an internal cache, the memory 704, or the storage device 706 and decode and execute them. In one or more embodiments, the processor 702 may include one or more internal caches for data, instructions, or addresses. As an example and not by way of limitation, the processor 702 may include one or more instruction caches, one or more data caches, and one or more translation lookaside buffers (TLBs). Instructions in the instruction caches may be copies of instructions in the memory 704 or the storage 906.

The memory 704 may be used for storing data, metadata, and programs for execution by the processor(s). The memory 704 may include one or more of volatile and non-volatile memories, such as Random Access Memory (“RAM”), Read Only Memory (“ROM”), a solid state disk (“SSD”), Flash, Phase Change Memory (“PCM”), or other types of data storage. The memory 704 may be internal or distributed memory.

The storage device 706 includes storage for storing data or instructions. As an example and not by way of limitation, storage device 706 can comprise a non-transitory storage medium described above. The storage device 706 may include a hard disk drive (HDD), a floppy disk drive, flash memory, an optical disc, a magneto-optical disc, magnetic tape, or a Universal Serial Bus (USB) drive or a combination of two or more of these. The storage device 706 may include removable or non-removable (or fixed) media, where appropriate. The storage device 706 may be internal or external to the computing device 700. In one or more embodiments, the storage device 706 is non-volatile, solid-state memory. In other embodiments, the storage device 706 includes read-only memory (ROM). Where appropriate, this ROM may be mask programmed ROM, programmable ROM (PROM), erasable PROM (EPROM), electrically erasable PROM (EEPROM), electrically alterable ROM (EAROM), or flash memory or a combination of two or more of these.

The I/O interface 708 allows a user to provide input to, receive output from, and otherwise transfer data to and receive data from computing device 700. The I/O interface 708 may include a mouse, a keypad or a keyboard, a touchscreen, a camera, an optical scanner, network interface, modem, other known I/O devices or a combination of such I/O interfaces. The I/O interface 708 may include one or more devices for presenting output to a user, including, but not limited to, a graphics engine, a display (e.g., a display screen), one or more output drivers (e.g., display drivers), one or more audio speakers, and one or more audio drivers. In certain embodiments, the I/O interface 708 is configured to provide graphical data to a display for presentation to a user. The graphical data may be representative of one or more graphical user interfaces and/or any other graphical content as may serve a particular implementation.

The communication interface 710 can include hardware, software, or both. In any event, the communication interface 710 can provide one or more interfaces for communication (such as, for example, packet-based communication) between the computing device 700 and one or more other computing devices or networks. As an example and not by way of limitation, the communication interface 710 may include a network interface controller (NIC) or network adapter for communicating with an Ethernet or other wire-based network or a wireless NIC (WNIC) or wireless adapter for communicating with a wireless network, such as a WI-FI.

Additionally, or alternatively, the communication interface 710 may facilitate communications with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, the communication interface 710 may facilitate communications with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination thereof.

Additionally, the communication interface 710 may facilitate communications various communication protocols. Examples of communication protocols that may be used include, but are not limited to, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Global System for Mobile Communications (“GSM”) technologies, Code Division Multiple Access (“CDMA”) technologies, Time Division Multiple Access (“TDMA”) technologies, Short Message Service (“SMS”), Multimedia Message Service (“MMS”), radio frequency (“RF”) signaling technologies, Long Term Evolution (“LTE”) technologies, wireless communication technologies, in-band and out-of-band signaling technologies, and other suitable communications networks and technologies.

The communication infrastructure 712 may include hardware, software, or both that couples components of the computing device 700 to each other. As an example and not by way of limitation, the communication infrastructure 712 may include a graphics bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Peripheral Component Interconnect (PCI) bus, a PCI-Express (PCIe) bus, a serial advanced technology attachment (SATA) bus, or another suitable bus or a combination thereof.

As mentioned above, the payment system 102 can comprise a social networking system. A social networking system may enable its users (such as persons or organizations) to interact with the system and with each other. As mentioned above, the payment system 102 can comprise a social networking system. A social networking system may enable its users (such as persons or organizations) to interact with the system and with each other. The social networking system may, with input from a user, create and store in the social networking system a user profile associated with the user. The user profile may include demographic information, communication-channel information, and information on personal interests of the user. The social networking system may also, with input from a user, create and store a record of relationships of the user with other users of the social networking system, as well as provide services (e.g. wall posts, photo-sharing, on-line calendars and event organization, messaging, games, or advertisements) to facilitate social interaction between or among users. Also, the social networking system may allow users to post photographs and other multimedia content items to a user's profile page (typically known as “wall posts” or “timeline posts”) or in a photo album, both of which may be accessible to other users of the social networking system depending upon the user's configured privacy settings.

FIG. 8 illustrates an example network environment 800 of a social networking system. Network environment 800 includes a client system 806, a social networking system 802, and a third-party system 808 connected to each other by a network 804. Although FIG. 8 illustrates a particular arrangement of client system 806, social networking system 802, third-party system 808, and network 804, this disclosure contemplates any suitable arrangement of client system 806, social networking system 802, third-party system 808, and network 804. As an example and not by way of limitation, two or more of client system 806, social networking system 802, and third-party system 808 may be connected to each other directly, bypassing network 804. As another example, two or more of client system 806, social networking system 802, and third-party system 808 may be physically or logically co-located with each other in whole or in part. Moreover, although FIG. 8 illustrates a particular number of client systems 806, social networking systems 802, third-party systems 808, and networks 804, this disclosure contemplates any suitable number of client systems 806, social networking systems 802, third-party systems 808, and networks 804. As an example and not by way of limitation, network environment 800 may include multiple client system 806, social networking systems 802, third-party systems 808, and networks 804.

This disclosure contemplates any suitable network 804. As an example and not by way of limitation, one or more portions of network 804 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 804 may include one or more networks 804.

Links may connect client system 806, social networking system 802, and third-party system 808 to communication network 804 or to each other. This disclosure contemplates any suitable links. In particular embodiments, one or more links include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links. Links need not necessarily be the same throughout network environment 800. One or more first links may differ in one or more respects from one or more second links.

In particular embodiments, client system 806 may be an electronic device including hardware, software, or embedded logic components or a combination of two or more such components and capable of carrying out the appropriate functionalities implemented or supported by client system 806. As an example and not by way of limitation, a client system 806 may include any of the computing devices discussed above in relation to FIG. 7. A client system 806 may enable a network user at client system 806 to access network 804. A client system 806 may enable its user to communicate with other users at other client systems 806.

In particular embodiments, client system 806 may include a web browser 932, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at client system 806 may enter a Uniform Resource Locator (URL) or other address directing the web browser to a particular server (such as server, or a server associated with a third-party system 808), and the web browser may generate a Hyper Text Transfer Protocol (HTTP) request and communicate the HTTP request to server. The server may accept the HTTP request and communicate to client system 806 one or more Hyper Text Markup Language (HTML) files responsive to the HTTP request. Client system 806 may render a webpage based on the HTML files from the server for presentation to the user. This disclosure contemplates any suitable webpage files. As an example and not by way of limitation, webpages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, social networking system 802 may be a network-addressable computing system that can host an online social network. Social networking system 802 may generate, store, receive, and send social-networking data, such as, for example, user-profile data, concept-profile data, social-graph information, or other suitable data related to the online social network. Social networking system 802 may be accessed by the other components of network environment 800 either directly or via network 804. In particular embodiments, social networking system 802 may include one or more servers. Each server may be a unitary server or a distributed server spanning multiple computers or multiple datacenters. Servers may be of various types, such as, for example and without limitation, web server, news server, mail server, message server, advertising server, file server, application server, exchange server, database server, proxy server, another server suitable for performing functions or processes described herein, or any combination thereof. In particular embodiments, each server may include hardware, software, or embedded logic components or a combination of two or more such components for carrying out the appropriate functionalities implemented or supported by server. In particular embodiments, social networking system 802 may include one or more data stores. Data stores may be used to store various types of information. In particular embodiments, the information stored in data stores may be organized according to specific data structures. In particular embodiments, each data store may be a relational, columnar, correlation, or other suitable database. Although this disclosure describes or illustrates particular types of databases, this disclosure contemplates any suitable types of databases. Particular embodiments may provide interfaces that enable a client system 806, a social networking system 802, or a third-party system 808 to manage, retrieve, modify, add, or delete, the information stored in data store.

In particular embodiments, social networking system 802 may store one or more social graphs in one or more data stores. In particular embodiments, a social graph may include multiple nodes—which may include multiple user nodes (each corresponding to a particular user) or multiple concept nodes (each corresponding to a particular concept)—and multiple edges connecting the nodes. Social networking system 802 may provide users of the online social network the ability to communicate and interact with other users. In particular embodiments, users may join the online social network via social networking system 802 and then add connections (e.g., relationships) to a number of other users of social networking system 802 whom they want to be connected to. Herein, the term “friend” may refer to any other user of social networking system 802 with whom a user has formed a connection, association, or relationship via social networking system 802.

In particular embodiments, social networking system 802 may provide users with the ability to take actions on various types of items or objects, supported by social networking system 802. As an example and not by way of limitation, the items and objects may include groups or social networks to which users of social networking system 802 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in social networking system 802 or by an external system of third-party system 808, which is separate from social networking system 802 and coupled to social networking system 802 via a network 804.

In particular embodiments, social networking system 802 may be capable of linking a variety of entities. As an example and not by way of limitation, social networking system 802 may enable users to interact with each other as well as receive content from third-party systems 808 or other entities, or to allow users to interact with these entities through an application programming interfaces (API) or other communication channels.

In particular embodiments, a third-party system 808 may include one or more types of servers, one or more data stores, one or more interfaces, including but not limited to APIs, one or more web services, one or more content sources, one or more networks, or any other suitable components, e.g., that servers may communicate with. A third-party system 808 may be operated by a different entity from an entity operating social networking system 802. In particular embodiments, however, social networking system 802 and third-party systems 808 may operate in conjunction with each other to provide social-networking services to users of social networking system 802 or third-party systems 808. In this sense, social networking system 802 may provide a platform, or backbone, which other systems, such as third-party systems 808, may use to provide social-networking services and functionality to users across the Internet.

In particular embodiments, a third-party system 808 may include a third-party content object provider. A third-party content object provider may include one or more sources of content objects, which may be communicated to a client system 806. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects.

In particular embodiments, social networking system 802 also includes user-generated content objects, which may enhance a user's interactions with social networking system 802. User-generated content may include anything a user can add, upload, send, or “post” to social networking system 802. As an example and not by way of limitation, a user communicates posts to social networking system 802 from a client system 806. Posts may include data such as status updates or other textual data, location information, photos, videos, links, music or other similar data or media. Content may also be added to social networking system 802 by a third-party through a “communication channel,” such as a newsfeed or stream.

In particular embodiments, social networking system 802 may include a variety of servers, sub-systems, programs, modules, logs, and data stores. In particular embodiments, social networking system 802 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. Social networking system 802 may also include suitable components such as network interfaces, security mechanisms, load balancers, failover servers, management-and-network-operations consoles, other suitable components, or any suitable combination thereof. In particular embodiments, social networking system 802 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking social networking system 802 to one or more client systems 806 or one or more third-party system 808 via network 804. The web server may include a mail server or other messaging functionality for receiving and routing messages between social networking system 802 and one or more client systems 806. An API-request server may allow a third-party system 808 to access information from social networking system 802 by calling one or more APIs. An action logger may be used to receive communications from a web server about a user's actions on or off social networking system 802. In conjunction with the action log, a third-party-content-object log may be maintained of user exposures to third-party-content objects. A notification controller may provide information regarding content objects to a client system 806. Information may be pushed to a client system 806 as notifications, or information may be pulled from client system 806 responsive to a request received from client system 806. Authorization servers may be used to enforce one or more privacy settings of the users of social networking system 802. A privacy setting of a user determines how particular information associated with a user can be shared. The authorization server may allow users to opt in to or opt out of having their actions logged by social networking system 802 or shared with other systems (e.g., third-party system 808), such as, for example, by setting appropriate privacy settings. Third-party-content-object stores may be used to store content objects received from third parties, such as a third-party system 808. Location stores may be used for storing location information received from client systems 806 associated with users. Advertisement-pricing modules may combine social information, the current time, location information, or other suitable information to provide relevant advertisements, in the form of notifications, to a user.

FIG. 9 illustrates example social graph 900. In particular embodiments, social networking system 802 may store one or more social graphs 900 in one or more data stores. In particular embodiments, social graph 900 may include multiple nodes—which may include multiple user nodes 902 or multiple concept nodes 904—and multiple edges 906 connecting the nodes. Example social graph 900 illustrated in FIG. 9 is shown, for didactic purposes, in a two-dimensional visual map representation. In particular embodiments, a social networking system 802, client system 806, or third-party system 808 may access social graph 900 and related social-graph information for suitable applications. The nodes and edges of social graph 900 may be stored as data objects, for example, in a data store (such as a social-graph database). Such a data store may include one or more searchable or query able indexes of nodes or edges of social graph 900.

In particular embodiments, a user node 902 may correspond to a user of social networking system 802. As an example and not by way of limitation, a user may be an individual (human user), an entity (e.g., an enterprise, business, or third-party application), or a group (e.g., of individuals or entities) that interacts or communicates with or over social networking system 802. In particular embodiments, when a user registers for an account with social networking system 802, social networking system 802 may create a user node 902 corresponding to the user, and store the user node 902 in one or more data stores. Users and user nodes 902 described herein may, where appropriate, refer to registered users and user nodes 902 associated with registered users. In addition, or as an alternative, users and user nodes 902 described herein may, where appropriate, refer to users that have not registered with social networking system 802. In particular embodiments, a user node 902 may be associated with information provided by a user or information gathered by various systems, including social networking system 802. As an example and not by way of limitation, a user may provide his or her name, profile picture, contact information, birth date, sex, marital status, family status, employment, education background, preferences, interests, or other demographic information. Each user node of the social graph may have a corresponding web page (typically known as a profile page). In response to a request including a user name, the social networking system can access a user node corresponding to the user name, and construct a profile page including the name, a profile picture, and other information associated with the user. A profile page of a first user may display to a second user all or a portion of the first user's information based on one or more privacy settings by the first user and the relationship between the first user and the second user.

In particular embodiments, a concept node 904 may correspond to a concept. As an example and not by way of limitation, a concept may correspond to a place (such as, for example, a movie theater, restaurant, landmark, or city); a website (such as, for example, a website associated with social-network system 802 or a third-party website associated with a web-application server); an entity (such as, for example, a person, business, group, sports team, or celebrity); a resource (such as, for example, an audio file, video file, digital photo, text file, structured document, or application) which may be located within social networking system 802 or on an external server, such as a web-application server; real or intellectual property (such as, for example, a sculpture, painting, movie, game, song, idea, photograph, or written work); a game; an activity; an idea or theory; another suitable concept; or two or more such concepts. A concept node 904 may be associated with information of a concept provided by a user or information gathered by various systems, including social networking system 802. As an example and not by way of limitation, information of a concept may include a name or a title; one or more images (e.g., an image of the cover page of a book); a location (e.g., an address or a geographical location); a website (which may be associated with a URL); contact information (e.g., a phone number or an email address); other suitable concept information; or any suitable combination of such information. In particular embodiments, a concept node 904 may be associated with one or more data objects corresponding to information associated with concept node 904. In particular embodiments, a concept node 904 may correspond to one or more webpages.

In particular embodiments, a node in social graph 900 may represent or be represented by a webpage (which may be referred to as a “profile page”). Profile pages may be hosted by or accessible to social networking system 802. Profile pages may also be hosted on third-party websites associated with a third-party server 808. As an example and not by way of limitation, a profile page corresponding to a particular external webpage may be the particular external webpage and the profile page may correspond to a particular concept node 904. Profile pages may be viewable by all or a selected subset of other users. As an example and not by way of limitation, a user node 902 may have a corresponding user-profile page in which the corresponding user may add content, make declarations, or otherwise express himself or herself. As another example and not by way of limitation, a concept node 904 may have a corresponding concept-profile page in which one or more users may add content, make declarations, or express themselves, particularly in relation to the concept corresponding to concept node 904.

In particular embodiments, a concept node 904 may represent a third-party webpage or resource hosted by a third-party system 808. The third-party webpage or resource may include, among other elements, content, a selectable or other icon, or other inter-actable object (which may be implemented, for example, in JavaScript, AJAX, or PHP codes) representing an action or activity. As an example and not by way of limitation, a third-party webpage may include a selectable icon such as “like,” “check in,” “eat,” “recommend,” or another suitable action or activity. A user viewing the third-party webpage may perform an action by selecting one of the icons (e.g., “eat”), causing a client system 806 to send to social networking system 802 a message indicating the user's action. In response to the message, social networking system 802 may create an edge (e.g., an “eat” edge) between a user node 902 corresponding to the user and a concept node 904 corresponding to the third-party webpage or resource and store edge 906 in one or more data stores.

In particular embodiments, a pair of nodes in social graph 900 may be connected to each other by one or more edges 906. An edge 906 connecting a pair of nodes may represent a relationship between the pair of nodes. In particular embodiments, an edge 906 may include or represent one or more data objects or attributes corresponding to the relationship between a pair of nodes. As an example and not by way of limitation, a first user may indicate that a second user is a “friend” of the first user. In response to this indication, social networking system 802 may send a “friend request” to the second user. If the second user confirms the “friend request,” social networking system 802 may create an edge 906 connecting the first user's user node 902 to the second user's user node 902 in social graph 900 and store edge 906 as social-graph information in one or more of data stores. In the example of FIG. 9, social graph 900 includes an edge 906 indicating a friend relation between user nodes 902 of user “A” and user “B” and an edge indicating a friend relation between user nodes 902 of user “C” and user “B.” Although this disclosure describes or illustrates particular edges 906 with particular attributes connecting particular user nodes 902, this disclosure contemplates any suitable edges 906 with any suitable attributes connecting user nodes 902. As an example and not by way of limitation, an edge 906 may represent a friendship, family relationship, business or employment relationship, fan relationship, follower relationship, visitor relationship, subscriber relationship, superior/subordinate relationship, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in social graph 900 by one or more edges 906.

In particular embodiments, an edge 906 between a user node 902 and a concept node 904 may represent a particular action or activity performed by a user associated with user node 902 toward a concept associated with a concept node 904. As an example and not by way of limitation, as illustrated in FIG. 9, a user may “like,” “attended,” “played,” “listened,” “cooked,” “worked at,” or “watched” a concept, each of which may correspond to an edge type or subtype. A concept-profile page corresponding to a concept node 904 may include, for example, a selectable “check in” icon (such as, for example, a clickable “check in” icon) or a selectable “add to favorites” icon. Similarly, after a user clicks these icons, social networking system 802 may create a “favorite” edge or a “check in” edge in response to a user's action corresponding to a respective action. As another example and not by way of limitation, a user (user “C”) may listen to a particular song (“Ramble On”) using a particular application (SPOTIFY, which is an online music application). In this case, social networking system 802 may create a “listened” edge 906 and a “used” edge (as illustrated in FIG. 9) between user nodes 902 corresponding to the user and concept nodes 904 corresponding to the song and application to indicate that the user listened to the song and used the application. Moreover, social networking system 802 may create a “played” edge 906 (as illustrated in FIG. 9) between concept nodes 904 corresponding to the song and the application to indicate that the particular song was played by the particular application. In this case, “played” edge 906 corresponds to an action performed by an external application (SPOTIFY) on an external audio file (the song “Imagine”). Although this disclosure describes particular edges 906 with particular attributes connecting user nodes 902 and concept nodes 904, this disclosure contemplates any suitable edges 906 with any suitable attributes connecting user nodes 902 and concept nodes 904. Moreover, although this disclosure describes edges between a user node 902 and a concept node 904 representing a single relationship, this disclosure contemplates edges between a user node 902 and a concept node 904 representing one or more relationships. As an example and not by way of limitation, an edge 906 may represent both that a user likes and has used at a particular concept. Alternatively, another edge 906 may represent each type of relationship (or multiples of a single relationship) between a user node 902 and a concept node 904 (as illustrated in FIG. 9 between user node 902 for user “E” and concept node 904 for “SPOTIFY”).

In particular embodiments, social networking system 802 may create an edge 906 between a user node 902 and a concept node 904 in social graph 900. As an example and not by way of limitation, a user viewing a concept-profile page (such as, for example, by using a web browser or a special-purpose application hosted by the user's client system 806) may indicate that he or she likes the concept represented by the concept node 904 by clicking or selecting a “Like” icon, which may cause the user's client system 806 to send to social networking system 802 a message indicating the user's liking of the concept associated with the concept-profile page. In response to the message, social networking system 802 may create an edge 906 between user node 902 associated with the user and concept node 904, as illustrated by “like” edge 906 between the user and concept node 904. In particular embodiments, social networking system 802 may store an edge 906 in one or more data stores. In particular embodiments, an edge 906 may be automatically formed by social networking system 802 in response to a particular user action. As an example and not by way of limitation, if a first user uploads a picture, watches a movie, or listens to a song, an edge 906 may be formed between user node 902 corresponding to the first user and concept nodes 904 corresponding to those concepts. Although this disclosure describes forming particular edges 906 in particular manners, this disclosure contemplates forming any suitable edges 906 in any suitable manner.

In particular embodiments, an advertisement may be text (which may be HTML-linked), one or more images (which may be HTML-linked), one or more videos, audio, one or more ADOBE FLASH files, a suitable combination of these, or any other suitable advertisement in any suitable digital format presented on one or more webpages, in one or more e-mails, or in connection with search results requested by a user. In addition, or as an alternative, an advertisement may be one or more sponsored stories (e.g., a news-feed or ticker item on social networking system 802). A sponsored story may be a social action by a user (such as “liking” a page, “liking” or commenting on a post on a page, RSVP'ing to an event associated with a page, voting on a question posted on a page, checking in to a place, using an application or playing a game, or “liking” or sharing a website) that an advertiser promotes, for example, by having the social action presented within a pre-determined area of a profile page of a user or other page, presented with additional information associated with the advertiser, bumped up or otherwise highlighted within news feeds or tickers of other users, or otherwise promoted. The advertiser may pay to have the social action promoted. As an example and not by way of limitation, advertisements may be included among the search results of a search-results page, where sponsored content is promoted over non-sponsored content.

In particular embodiments, an advertisement may be requested for display within social-networking-system webpages, third-party webpages, or other pages. An advertisement may be displayed in a dedicated portion of a page, such as in a banner area at the top of the page, in a column at the side of the page, in a GUI of the page, in a pop-up window, in a drop-down menu, in an input field of the page, over the top of content of the page, or elsewhere with respect to the page. In addition, or as an alternative, an advertisement may be displayed within an application. An advertisement may be displayed within dedicated pages, requiring the user to interact with or watch the advertisement before the user may access a page or utilize an application. The user may, for example view the advertisement through a web browser.

A user may interact with an advertisement in any suitable manner. The user may click or otherwise select the advertisement. By selecting the advertisement, the user may be directed to (or a browser or other application being used by the user) a page associated with the advertisement. At the page associated with the advertisement, the user may take additional actions, such as purchasing a product or service associated with the advertisement, receiving information associated with the advertisement, or subscribing to a newsletter associated with the advertisement. An advertisement with audio or video may be played by selecting a component of the advertisement (like a “play button”). Alternatively, by selecting the advertisement, social networking system 802 may execute or modify a particular action of the user.

An advertisement may also include social-networking-system functionality that a user may interact with. As an example and not by way of limitation, an advertisement may enable a user to “like” or otherwise endorse the advertisement by selecting an icon or link associated with endorsement. As another example and not by way of limitation, an advertisement may enable a user to search (e.g., by executing a query) for content related to the advertiser. Similarly, a user may share the advertisement with another user (e.g., through social networking system 802) or RSVP (e.g., through social networking system 802) to an event associated with the advertisement. In addition, or as an alternative, an advertisement may include social-networking-system context directed to the user. As an example and not by way of limitation, an advertisement may display information about a friend of the user within social networking system 802 who has taken an action associated with the subject matter of the advertisement.

In particular embodiments, social networking system 802 may determine the social-graph affinity (which may be referred to herein as “affinity”) of various social-graph entities for each other. Affinity may represent the strength of a relationship or level of interest between particular objects associated with the online social network, such as users, concepts, content, actions, advertisements, other objects associated with the online social network, or any suitable combination thereof. Affinity may also be determined with respect to objects associated with third-party systems 808 or other suitable systems. An overall affinity for a social-graph entity for each user, subject matter, or type of content may be established. The overall affinity may change based on continued monitoring of the actions or relationships associated with the social-graph entity. Although this disclosure describes determining particular affinities in a particular manner, this disclosure contemplates determining any suitable affinities in any suitable manner.

In particular embodiments, social networking system 802 may measure or quantify social-graph affinity using an affinity coefficient (which may be referred to herein as “coefficient”). The coefficient may represent or quantify the strength of a relationship between particular objects associated with the online social network. The coefficient may also represent a probability or function that measures a predicted probability that a user will perform a particular action based on the user's interest in the action. In this way, a user's future actions may be predicted based on the user's prior actions, where the coefficient may be calculated at least in part on the history of the user's actions. Coefficients may be used to predict any number of actions, which may be within or outside of the online social network. As an example and not by way of limitation, these actions may include various types of communications, such as sending messages, posting content, or commenting on content; various types of a observation actions, such as accessing or viewing profile pages, media, or other suitable content; various types of coincidence information about two or more social-graph entities, such as being in the same group, tagged in the same photograph, checked-in at the same location, or attending the same event; or other suitable actions. Although this disclosure describes measuring affinity in a particular manner, this disclosure contemplates measuring affinity in any suitable manner.

In particular embodiments, social networking system 802 may use a variety of factors to calculate a coefficient. These factors may include, for example, user actions, types of relationships between objects, location information, other suitable factors, or any combination thereof. In particular embodiments, different factors may be weighted differently when calculating the coefficient. The weights for each factor may be static or the weights may change according to, for example, the user, the type of relationship, the type of action, the user's location, and so forth. Ratings for the factors may be combined according to their weights to determine an overall coefficient for the user. As an example and not by way of limitation, particular user actions may be assigned both a rating and a weight while a relationship associated with the particular user action is assigned a rating and a correlating weight (e.g., so the weights total 100%). To calculate the coefficient of a user towards a particular object, the rating assigned to the user's actions may comprise, for example, 60% of the overall coefficient, while the relationship between the user and the object may comprise 40% of the overall coefficient. In particular embodiments, the social networking system 802 may consider a variety of variables when determining weights for various factors used to calculate a coefficient, such as, for example, the time since information was accessed, decay factors, frequency of access, relationship to information or relationship to the object about which information was accessed, relationship to social-graph entities connected to the object, short- or long-term averages of user actions, user feedback, other suitable variables, or any combination thereof. As an example and not by way of limitation, a coefficient may include a decay factor that causes the strength of the signal provided by particular actions to decay with time, such that more recent actions are more relevant when calculating the coefficient. The ratings and weights may be continuously updated based on continued tracking of the actions upon which the coefficient is based. Any type of process or algorithm may be employed for assigning, combining, averaging, and so forth the ratings for each factor and the weights assigned to the factors. In particular embodiments, social networking system 802 may determine coefficients using machine-learning algorithms trained on historical actions and past user responses, or data farmed from users by exposing them to various options and measuring responses. Although this disclosure describes calculating coefficients in a particular manner, this disclosure contemplates calculating coefficients in any suitable manner.

In particular embodiments, social networking system 802 may calculate a coefficient based on a user's actions. Social networking system 802 may monitor such actions on the online social network, on a third-party system 808, on other suitable systems, or any combination thereof Any suitable type of user actions may be tracked or monitored. Typical user actions include viewing profile pages, creating or posting content, interacting with content, joining groups, listing and confirming attendance at events, checking-in at locations, liking particular pages, creating pages, and performing other tasks that facilitate social action. In particular embodiments, social networking system 802 may calculate a coefficient based on the user's actions with particular types of content. The content may be associated with the online social network, a third-party system 808, or another suitable system. The content may include users, profile pages, posts, news stories, headlines, instant messages, chat room conversations, emails, advertisements, pictures, video, music, other suitable objects, or any combination thereof. Social networking system 802 may analyze a user's actions to determine whether one or more of the actions indicate an affinity for subject matter, content, other users, and so forth. As an example and not by way of limitation, if a user may make frequently posts content related to “coffee” or variants thereof, social networking system 802 may determine the user has a high coefficient with respect to the concept “coffee”. Particular actions or types of actions may be assigned a higher weight and/or rating than other actions, which may affect the overall calculated coefficient. As an example and not by way of limitation, if a first user emails a second user, the weight or the rating for the action may be higher than if the first user simply views the user-profile page for the second user.

In particular embodiments, social networking system 802 may calculate a coefficient based on the type of relationship between particular objects. Referencing the social graph 900, social networking system 802 may analyze the number and/or type of edges 906 connecting particular user nodes 902 and concept nodes 904 when calculating a coefficient. As an example and not by way of limitation, user nodes 902 that are connected by a spouse-type edge (representing that the two users are married) may be assigned a higher coefficient than user nodes 902 that are connected by a friend-type edge. In other words, depending upon the weights assigned to the actions and relationships for the particular user, the overall affinity may be determined to be higher for content about the user's spouse than for content about the user's friend. In particular embodiments, the relationships a user has with another object may affect the weights and/or the ratings of the user's actions with respect to calculating the coefficient for that object. As an example and not by way of limitation, if a user is tagged in first photo, but merely likes a second photo, social networking system 802 may determine that the user has a higher coefficient with respect to the first photo than the second photo because having a tagged-in-type relationship with content may be assigned a higher weight and/or rating than having a like-type relationship with content. In particular embodiments, social networking system 802 may calculate a coefficient for a first user based on the relationship one or more second users have with a particular object. In other words, the connections and coefficients other users have with an object may affect the first user's coefficient for the object. As an example and not by way of limitation, if a first user is connected to or has a high coefficient for one or more second users, and those second users are connected to or have a high coefficient for a particular object, social networking system 802 may determine that the first user should also have a relatively high coefficient for the particular object. In particular embodiments, the coefficient may be based on the degree of separation between particular objects. Degree of separation between any two nodes is defined as the minimum number of hops required to traverse the social graph from one node to the other. A degree of separation between two nodes can be considered a measure of relatedness between the users or the concepts represented by the two nodes in the social graph. For example, two users having user nodes that are directly connected by an edge (i.e., are first-degree nodes) may be described as “connected users” or “friends.” Similarly, two users having user nodes that are connected only through another user node (i.e., are second-degree nodes) may be described as “friends of friends.” The lower coefficient may represent the decreasing likelihood that the first user will share an interest in content objects of the user that is indirectly connected to the first user in the social graph 900. As an example and not by way of limitation, social-graph entities that are closer in the social graph 900 (i.e., fewer degrees of separation) may have a higher coefficient than entities that are further apart in the social graph 900.

In particular embodiments, social networking system 802 may calculate a coefficient based on location information. Objects that are geographically closer to each other may be considered to be more related, or of more interest, to each other than more distant objects. In particular embodiments, the coefficient of a user towards a particular object may be based on the proximity of the object's location to a current location associated with the user (or the location of a client system 806 of the user). A first user may be more interested in other users or concepts that are closer to the first user. As an example and not by way of limitation, if a user is one mile from an airport and two miles from a gas station, social networking system 802 may determine that the user has a higher coefficient for the airport than the gas station based on the proximity of the airport to the user.

In particular embodiments, social networking system 802 may perform particular actions with respect to a user based on coefficient information. Coefficients may be used to predict whether a user will perform a particular action based on the user's interest in the action. A coefficient may be used when generating or presenting any type of objects to a user, such as advertisements, search results, news stories, media, messages, notifications, or other suitable objects. The coefficient may also be utilized to rank and order such objects, as appropriate. In this way, social networking system 802 may provide information that is relevant to user's interests and current circumstances, increasing the likelihood that they will find such information of interest. In particular embodiments, social networking system 802 may generate content based on coefficient information. Content objects may be provided or selected based on coefficients specific to a user. As an example and not by way of limitation, the coefficient may be used to generate media for the user, where the user may be presented with media for which the user has a high overall coefficient with respect to the media object. As another example and not by way of limitation, the coefficient may be used to generate advertisements for the user, where the user may be presented with advertisements for which the user has a high overall coefficient with respect to the advertised object. In particular embodiments, social networking system 802 may generate search results based on coefficient information. Search results for a particular user may be scored or ranked based on the coefficient associated with the search results with respect to the querying user. As an example and not by way of limitation, search results corresponding to objects with higher coefficients may be ranked higher on a search-results page than results corresponding to objects having lower coefficients.

In particular embodiments, social networking system 802 may calculate a coefficient in response to a request for a coefficient from a particular system or process. To predict the likely actions a user may take (or may be the subject of) in a given situation, any process may request a calculated coefficient for a user. The request may also include a set of weights to use for various factors used to calculate the coefficient. This request may come from a process running on the online social network, from a third-party system 808 (e.g., via an API or other communication channel), or from another suitable system. In response to the request, social networking system 802 may calculate the coefficient (or access the coefficient information if it has previously been calculated and stored). In particular embodiments, social networking system 802 may measure an affinity with respect to a particular process. Different processes (both internal and external to the online social network) may request a coefficient for a particular object or set of objects. Social networking system 802 may provide a measure of affinity that is relevant to the particular process that requested the measure of affinity. In this way, each process receives a measure of affinity that is tailored for the different context in which the process will use the measure of affinity.

In connection with social-graph affinity and affinity coefficients, particular embodiments may utilize one or more systems, components, elements, functions, methods, operations, or steps disclosed in U.S. patent application Ser. No. 11/503093, filed 11 Aug. 2006, U.S. patent application Ser. No. 12/978027, filed 22 Dec. 2010, U.S. patent application Ser. No. 12/978265, filed 23 Dec. 2010, and U.S. patent application Ser. No. 13/642869, field 1 Oct. 2012, each of which is incorporated by reference.

In particular embodiments, one or more of the content objects of the online social network may be associated with a privacy setting. The privacy settings (or “access settings”) for an object may be stored in any suitable manner, such as, for example, in association with the object, in an index on an authorization server, in another suitable manner, or any combination thereof. A privacy setting of an object may specify how the object (or particular information associated with an object) can be accessed (e.g., viewed or shared) using the online social network. Where the privacy settings for an object allow a particular user to access that object, the object may be described as being “visible” with respect to that user. As an example and not by way of limitation, a user of the online social network may specify privacy settings for a user-profile page identify a set of users that may access the work experience information on the user-profile page, thus excluding other users from accessing the information. In particular embodiments, the privacy settings may specify a “blocked list” of users that should not be allowed to access certain information associated with the object. In other words, the blocked list may specify one or more users or entities for which an object is not visible. As an example and not by way of limitation, a user may specify a set of users that may not access photos albums associated with the user, thus excluding those users from accessing the photo albums (while also possibly allowing certain users not within the set of users to access the photo albums). In particular embodiments, privacy settings may be associated with particular social-graph elements. Privacy settings of a social-graph element, such as a node or an edge, may specify how the social-graph element, information associated with the social-graph element, or content objects associated with the social-graph element can be accessed using the online social network. As an example and not by way of limitation, a particular concept node 904 corresponding to a particular photo may have a privacy setting specifying that the photo may only be accessed by users tagged in the photo and their friends. In particular embodiments, privacy settings may allow users to opt in or opt out of having their actions logged by social networking system 802 or shared with other systems (e.g., third-party system 808). In particular embodiments, the privacy settings associated with an object may specify any suitable granularity of permitted access or denial of access. As an example and not by way of limitation, access or denial of access may be specified for particular users (e.g., only me, my roommates, and my boss), users within a particular degrees-of-separation (e.g., friends, or friends-of-friends), user groups (e.g., the gaming club, my family), user networks (e.g., employees of particular employers, students or alumni of particular university), all users (“public”), no users (“private”), users of third-party systems 808, particular applications (e.g., third-party applications, external websites), other suitable users or entities, or any combination thereof. Although this disclosure describes using particular privacy settings in a particular manner, this disclosure contemplates using any suitable privacy settings in any suitable manner.

In particular embodiments, one or more servers may be authorization/privacy servers for enforcing privacy settings. In response to a request from a user (or other entity) for a particular object stored in a data store, social networking system 802 may send a request to the data store for the object. The request may identify the user associated with the request and may only be sent to the user (or a client system 806 of the user) if the authorization server determines that the user is authorized to access the object based on the privacy settings associated with the object. If the requesting user is not authorized to access the object, the authorization server may prevent the requested object from being retrieved from the data store, or may prevent the requested object from be sent to the user. In the search query context, an object may only be generated as a search result if the querying user is authorized to access the object. In other words, the object must have a visibility that is visible to the querying user. If the object has a visibility that is not visible to the user, the object may be excluded from the search results. Although this disclosure describes enforcing privacy settings in a particular manner, this disclosure contemplates enforcing privacy settings in any suitable manner.

The foregoing specification is described with reference to specific exemplary embodiments thereof. Various embodiments and aspects of the disclosure are described with reference to details discussed herein, and the accompanying drawings illustrate the various embodiments. The description above and drawings are illustrative and are not to be construed as limiting. Numerous specific details are described to provide a thorough understanding of various embodiments.

The additional or alternative embodiments may be embodied in other specific forms without departing from its spirit or essential characteristics. The described embodiments are to be considered in all respects only as illustrative and not restrictive. The scope of the present disclosure is, therefore, indicated by the appended claims rather than by the foregoing description. All changes that come within the meaning and range of equivalency of the claims are to be embraced within their scope.

What is claimed is:

1. A method, comprising:
identifying, by at least one processor, a payment request by a user to initiate a payment transaction with a recipient via a networking application on a client device;
determining, by the at least one processor, a financial system corresponding to a banking application installed on the client device, the financial system associated with a payment account of the user;
sending, by the at least one processor, a notification of the payment request to the financial system, the notification comprising a payment amount and a recipient identifier associated with the payment request;
performing an app switch to a login interface associated with the banking application, the login interface requesting login information for the payment account of the user; and
processing the payment transaction using the payment account of the user using an authorization from the financial system, the authorization based on the user logging into the payment account via the banking application on the client device.

2. The method as recited in claim 1, further comprising receiving a tokenized credential from the financial system in response to the processed payment transaction, the tokenized credential corresponding to the payment account of the user.

3. The method as recited in claim 2, further comprising:
identifying a second payment request by the user to initiate a second payment transaction via the networking system;
sending the tokenized credential with the second payment request to the financial system; and
processing the second payment transaction using the payment account of the user using an authorization from the financial system, the authorization based on the tokenized credential.

4. The method as recited in claim 1, further comprising:
detecting that the user has entered the login information in the login interface; and
performing an app switch back to the networking application from the login interface of the banking application in response to the user entering the login information in to the login interface.

5. The method as recited in claim 4, further comprising:
providing an authorization interface in the networking application to the user in response to the user entering the login information in to the login interface;
receiving authorization from the user in the authorization interface; and
sending an authorization message to the financial system to complete the payment transaction.

6. The method as recited in claim 1, wherein determining the financial system corresponding to the banking application installed on the client device comprises:
identifying a plurality of banking applications installed on the client device;
displaying the plurality of banking applications in the network application; and
receiving a selection of a banking application from the plurality of banking applications.

7. The method as recited in claim 1, wherein determining the financial system corresponding to the banking application installed on the client device comprises:
receiving a user selection of the financial system in the networking application;
sending a request to the financial system for an installation location of the banking application;
receiving a response from the financial system indicating the installation location of the banking application; and
locating the banking application on the client device based on the response from the banking application.

8. The method as recited in claim 1, further comprising:
receiving security information from the financial system in connection with the user entering the login information in to the login interface; and
determining that the security information matches user account information in a networking system, the networking system corresponding to the networking application.

9. The method as recited in claim 8, wherein determining that the security information matches user account information in the networking system comprises:
identifying a security question from the security information;
determining that the user account information in the networking system comprises an answer to the security question; and
verifying the security information to the financial system.

10. A non-transitory computer readable medium storing instructions thereon that, when executed by at least one processor, cause a computer system to:
identify a payment request by a user to initiate a payment transaction with a recipient via a networking application on a client device;
determine a financial system corresponding to a banking application installed on the client device, the financial system associated with a payment account of the user;
send a notification of the payment request to the financial system, the notification comprising a payment amount and a recipient identifier associated with the payment request;
perform an app switch to a login interface associated with the banking application, the login interface requesting login information for the payment account of the user; and
process the payment transaction using the payment account of the user using an authorization from the financial system, the authorization based on the user logging into the payment account via the banking application on the client device.

11. The non-transitory computer readable medium as recited in claim 10, further comprising instructions that, when executed by the at least one processor, cause the computer system to:
receive a tokenized credential from the financial system in response to the processed payment transaction, the tokenized credential corresponding to the payment account of the user;
identify a second payment request by the user to initiate a second payment transaction via the networking system;
send the tokenized credential with the second payment request to the financial system; and
process the second payment transaction using the payment account of the user using an authorization from the financial system, the authorization based on the tokenized credential.

12. The non-transitory computer readable medium as recited in claim 10, further comprising instructions that, when executed by the at least one processor, cause the computer system to:
detect that the user has entered the login information in the login interface; and
perform an app switch back to the networking application from the login interface of the banking application in response to the user entering the login information in to the login interface.

13. The non-transitory computer readable medium as recited in claim 10, further comprising instructions that, when executed by the at least one processor, cause the computer system to determine the financial system corresponding to the banking application installed on the client device by:
identifying a plurality of banking applications installed on the client device;
displaying the plurality of banking applications in the network application; and
receiving a selection of a banking application from the plurality of banking applications.

14. The non-transitory computer readable medium as recited in claim 10, further comprising instructions that, when executed by the at least one processor, cause the computer system to determine the financial system corresponding to the banking application installed on the client device by:
detecting a selection of the banking application installed on the client device; and
determining the financial system based on the selected banking application.

15. The non-transitory computer readable medium as recited in claim 10, further comprising instructions that, when executed by the at least one processor, cause the computer system to:
receive security information from the financial system in connection with the user entering the login information in to the login interface;
identify a security question from the security information;
determine that the user account information in the networking system comprises an answer to the security question; and
verify the security information to the financial system.

16. A system comprising:
at least one processor; and
at least one non-transitory computer readable storage medium storing instructions that, when executed by the at least one processor, cause the system to:
identify a payment request by a user to initiate a payment transaction with a recipient via a networking application on a client device;
determine a financial system corresponding to a banking application installed on the client device, the financial system associated with a payment account of the user;
send a notification of the payment request to the financial system, the notification comprising a payment amount and a recipient identifier associated with the payment request;
perform an app switch to a login interface associated with the banking application to the user, the login interface requesting login information for the payment account of the user; and
process the payment transaction using the payment account of the user using an authorization from the financial system, the authorization based on the user logging into the payment account via the banking application on the client device.

17. The system as recited in claim 16, further comprising instructions that, when executed by the at least one processor, cause the computer system to:
receive a tokenized credential from the financial system in response to the processed payment transaction, the tokenized credential corresponding to the payment account of the user;
send the tokenized credential with one or more additional payment requests to initiate one or more additional payment transactions to the financial system; and
process the one or more additional payment transaction using the payment account of the user using an authorization from the financial system, the authorization based on the tokenized credential.

18. The system as recited in claim 16, further comprising instructions that, when executed by the at least one processor, cause the computer system to:
identify a plurality of banking applications installed on the client device;
display the plurality of banking applications in the network application; and
receive a selection of a banking application from the plurality of banking applications.

19. The system as recited in claim 16, further comprising instructions that, when executed by the at least one processor, cause the computer system to:
receive security information from the financial system in connection with the user entering the login information in to the login interface; and
determine that the security information matches user account information in a networking system, the networking system corresponding to the networking application.

20. The system as recited in claim 19, further comprising instructions that, when executed by the at least one processor, cause the computer system to determine that the security information matches user account information in the networking system by:
identifying a security question from the security information;
determining that the user account information in the networking system comprises an answer to the security question; and
verifying the security information to the financial system.
